(19) United States
(12) Patent Application Publication
(10) Pub. No.: US 2025/0287101 A1
(43) Pub. Date: Sep. 11, 2025

(54) METHOD FOR CONTROLLING OPTICAL DEVICE

(71) Applicant: NIDEC PRECISION CORPORATION, Tokyo (JP)

(72) Inventor: Shigemi TAKAHASHI, Tokyo (JP)

(21) Appl. No.: 19/071,754

(22) Filed: Mar. 6, 2025

(30) Foreign Application Priority Data
Mar. 7, 2024 (JP) 2024-035355

(51) Int. Cl. H04N 23/68; H04N 23/61; H04N 23/695

(52) U.S. Cl. CPC H04N 23/685; H04N 23/61; H04N 23/695

(57) ABSTRACT

An optical device includes an imager, an actuator to change the angle of the imager, and a gyro sensor to obtain information about a deviation angle of the imager. A method for controlling the optical device includes specifying a subject, defining an imaginary line connecting the centers of the imager and subject as a reference line, setting a threshold of the deviation angle of the imager in a direction intersecting the reference line, changing, with the actuator, the angle of the imager along the reference line, obtaining, with the gyro sensor, the information about the deviation angle, changing, with the actuator, the angle of the imager until the deviation angle falls below the threshold in response to the deviation angle exceeding the threshold, and continuing an operation of changing, with the actuator, the angle of the imager along the reference line after the deviation angle falls below the threshold.

### RELATED APPLICATIONS

The present application claims priority to Japanese Application Number 2024-035355, filed Mar. 7, 2024, the disclosure of which is hereby incorporated by reference herein in its entirety.

### BACKGROUND

### Technical Field

The disclosure relates to a method for controlling an optical device.

### Description of the Background

Patent Literature 1 describes a camera control device that controls a camera to pan, tilt, and zoom. The camera control device includes a face detector that detects the face of a presenter in an image captured with the camera, and a first control unit that controls the camera to pan, tilt, or zoom to allow the face to be detected when the face is not detected by the face detector.

### CITATION LIST

### Patent Literature

Patent Literature 1: Japanese Unexamined Patent Application Publication No. 2010-087613

### BRIEF SUMMARY

When the angle of an imager is changed toward a subject as in the structure in Patent Literature 1, the imager may receive vibrations. For example, an optical device may receive vibrations from, for example, an earthquake during imaging of a subject with the optical device placed on a desk, or may receive vibrations when the subject is walking and taking a selfie with the optical device. As described above, the optical device may receive vibrations in changing the angle of the imager toward the subject, possibly causing image blur.

One or more aspects of the disclosure are directed to a technique for reducing image blur that may occur with vibrations received by an optical device in changing the angle of an imager toward a subject.

A method according to an aspect of the disclosure is a method for controlling an optical device. The optical device includes an imager, a drive to change an angle of the imager, and an obtainer to obtain information about a deviation angle from a reference angle of the imager. The method includes specifying at least one subject, defining, in response to the at least one subject being specified, an imaginary line connecting a center of the imager and a center of the at least one subject as a reference line representing the reference angle, setting at least one threshold of the deviation angle from the reference angle of the imager in an intersecting direction intersecting with the reference line, starting an operation of changing, with the drive, the angle of the imager along the reference line, obtaining, with the obtainer, the information about the deviation angle in the intersecting direction, changing, with the drive, the angle of the imager until the deviation angle in the intersecting direction falls below the at least one threshold in response to the deviation angle in the intersecting direction exceeding the at least one threshold in changing, with the drive, the angle of the imager along the reference line, and continuing the operation of changing, with the drive, the angle of the imager along the reference line after the deviation angle in the intersecting direction falls below the at least one threshold.

The method according to the above aspect of the disclosure can reduce image blur that may occur with vibrations received by the optical device in changing the angle of the imager toward the subject.

### BRIEF DESCRIPTION OF DRAWINGS

FIG. 1 is a diagram describing an optical device according to a first embodiment operated with a communication terminal.

FIG. 2 is a block diagram of the optical device and the communication terminal shown in FIG. 1, showing their internal structures.

FIG. 3 is a partial cross-sectional view of the optical device shown in FIG. 1, showing its internal structure.

FIG. 4 is a partial plan view of the optical device shown in FIG. 3, showing its internal structure.

FIG. 5 is a partial perspective view of the optical device shown in FIG. 3, showing its internal structure.

FIG. 6 is a diagram showing image patterns of a subject obtained by operating the optical device placed on a desk.

FIG. 7 is a table showing correction patterns for a deviation angle that can be set in the optical device shown in FIG. 1.

FIG. 8 is a graph showing, for example, a reference line used to correct the deviation angle of the optical device shown in FIG. 1.

FIG. 9 is a flowchart of the processes for correcting the deviation angle in the optical device shown in FIG. 1.

FIG. 10 is a graph showing correction of the deviation angle of the optical device shown in FIG. 1.

FIG. 11 is a diagram of an optical device according to a second embodiment capturing an image of the face of a subject who is seated and an image of the face of the subject who is standing.

FIG. 12 is a block diagram of a communication terminal in the second embodiment, showing its internal structure.

FIG. 13A is a graph showing reference lines and boundaries set for the optical device shown in FIG. 11 when the face position of the subject changes.

FIG. 13B is a graph showing, when the face position of the subject changes in the optical device shown in FIG. 11, the acceleration of a drive to change the angle of the imager changed at time points.

FIG. 14 is a flowchart of the processes for correcting the deviation angle in imaging performed with the subject tracked by the optical device shown in FIG. 11.

FIG. 15 is a diagram of the subject taking a selfie with an optical device according to a third embodiment.

FIG. 16 is a graph showing a reference line, boundaries, and limit lines set in the optical device shown in FIG. 15.

FIG. 17 is a flowchart of the processes for correcting the deviation angle in imaging performed with the subject tracked by the optical device shown in FIG. 15.

FIG. 18 is a diagram showing image patterns when the orientation of the imager is switched from a first subject to a second subject in an optical device according to a fourth embodiment.

FIG. 19 is a graph showing reference lines and boundaries set when the subject is switched to the second subject during imaging of the first subject in the optical device shown in FIG. 18.

FIG. 20 is a flowchart of the processes for correcting the deviation angle in imaging performed with the subject switched in the optical device shown in FIG. 18.

### DETAILED DESCRIPTION

Embodiments and modifications of the disclosure will now be described in detail with reference to the drawings. In the drawings used to describe the embodiments and the modifications, the same reference numerals denote the same or substantially the same components or elements. The components or elements described once will not basically be described repeatedly. Unless otherwise specified, the terms such as first and second will be used simply to distinguish the components and will not represent a specific order or sequence.

### Components in First Embodiment

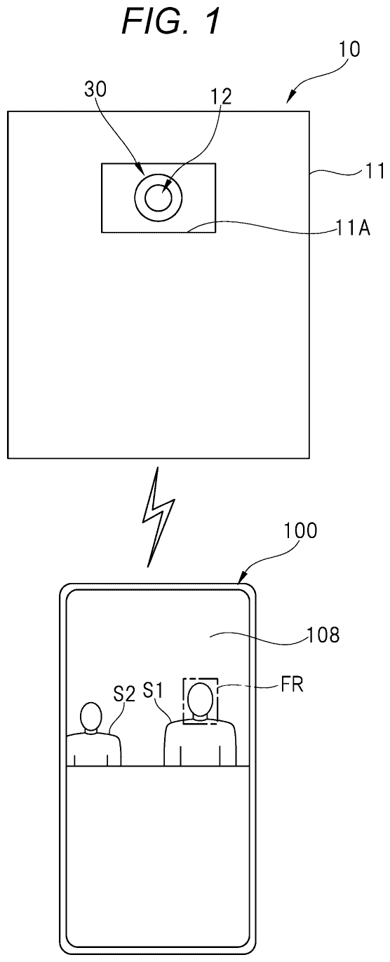

FIG. 1 shows an optical device 10 according to a first embodiment. The optical device 10 includes a body case 11, an imager 12, and an actuator 30. The body case 11 has an opening 11A. The imager 12 is accommodated in the body case 11. The imager 12 is partially visible from outside the body case 11 through the opening 11A. The actuator 30 changes the angle of the imager 12.

The optical device 10 operates by, for example, transmitting and receiving information to and from a communication terminal 100. The communication terminal 100 is a mobile terminal with wireless communication capabilities operable by a user. The user may not be a subject. The communication terminal 100 may be a smartphone or a tablet. The communication between the communication terminal 100 and the optical device 10 is performed using, for example, Bluetooth (registered trademark). The communication may be performed using Wi-Fi (registered trademark).

For example, a first subject S1, a second subject S2, and a selection frame FR appear on a display panel 108 (described later) in the communication terminal 100.

### Communication Terminal

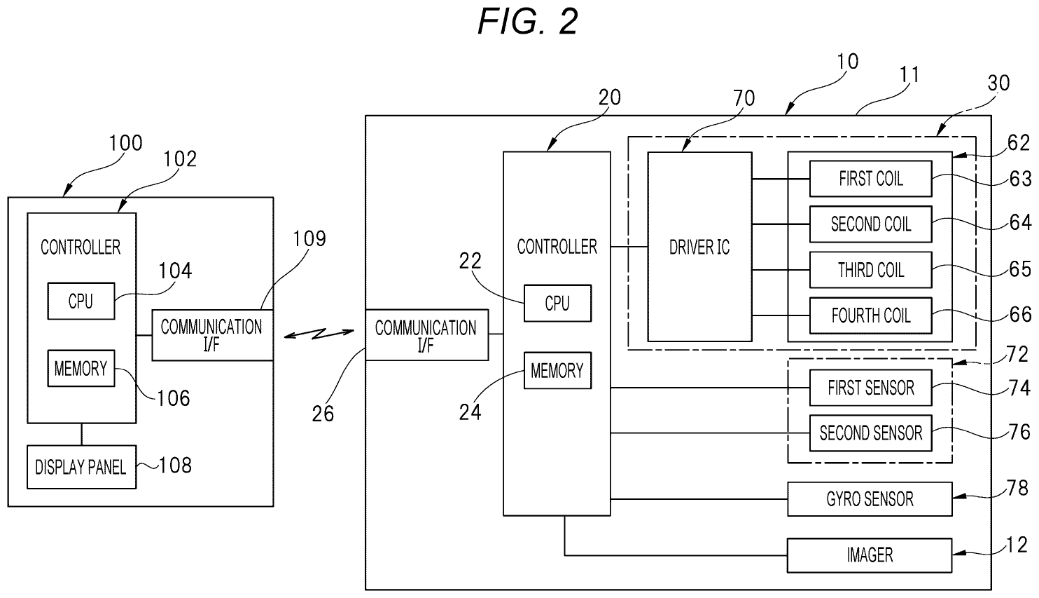

As shown in FIG. 2, the communication terminal 100 includes a controller 102, the display panel 108, and a communication interface (I/F) 109. The controller 102 includes a central processing unit (CPU) 104 and a memory 106. The memory 106 stores multiple programs for controlling the optical device 10.

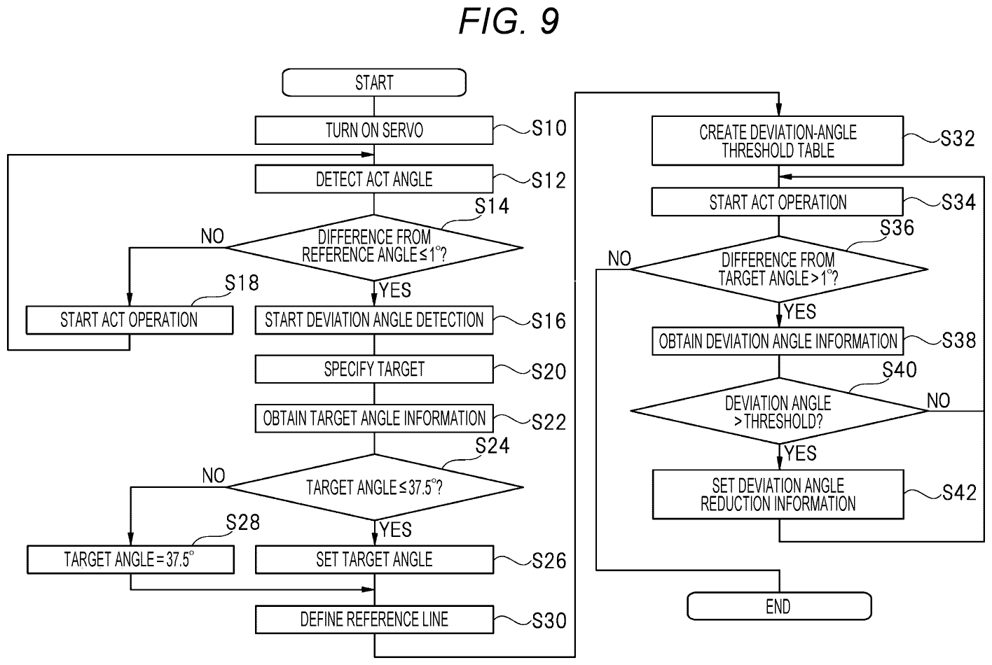

The controller 102 controls the operation of the optical device 10. The multiple programs stored in the controller 102 include a program for changing the angle of the imager 12 (described later) and correcting the deviation angle of the imager 12. The processes performed with the above program will be described later with reference to a flowchart (FIG. 9).

The display panel 108 functions as a touchscreen. On the display panel 108, subjects including the user can appear or various items can be set through the operation by the user. The setting using the display panel 108 includes setting for user face authentication and setting for, for example, selecting subjects to be imaged. The communication I/F 109 wirelessly communicates with a communication I/F 26 (described later).

The selection frame FR (FIG. 1) that is quadrilateral appears on the display panel 108. The user can move the selection frame FR to an intended position by touching the display panel 108 with a finger. For example, the selection frame FR is set around the face of the first subject S1 (FIG. 1). The center of a target in the selection frame FR is at the center of an image obtained by the imager 12. In other words, the actuator 30 operates to change the angle of the imager 12 and cause the center of a target specified with the selection frame FR to be at the center of an image.

### Optical Device

As shown in FIG. 2, the optical device 10 includes the body case 11, the imager 12, a controller 20, the actuator 30, a detector 72, a gyro sensor 78, the communication I/F 26, and a battery (not shown). The controller 20 includes a CPU 22 and a memory 24. The memory 24 stores a program for transmitting and receiving signals to and from components of the optical device 10.

The controller 20 causes the components of the optical device 10 to operate based on commands received from the communication terminal 100. The controller 20 mediates transmission and reception of signals between the controller 102 and the components of the optical device 10. The communication I/F 26 wirelessly communicates with the communication I/F 109.

### Imager

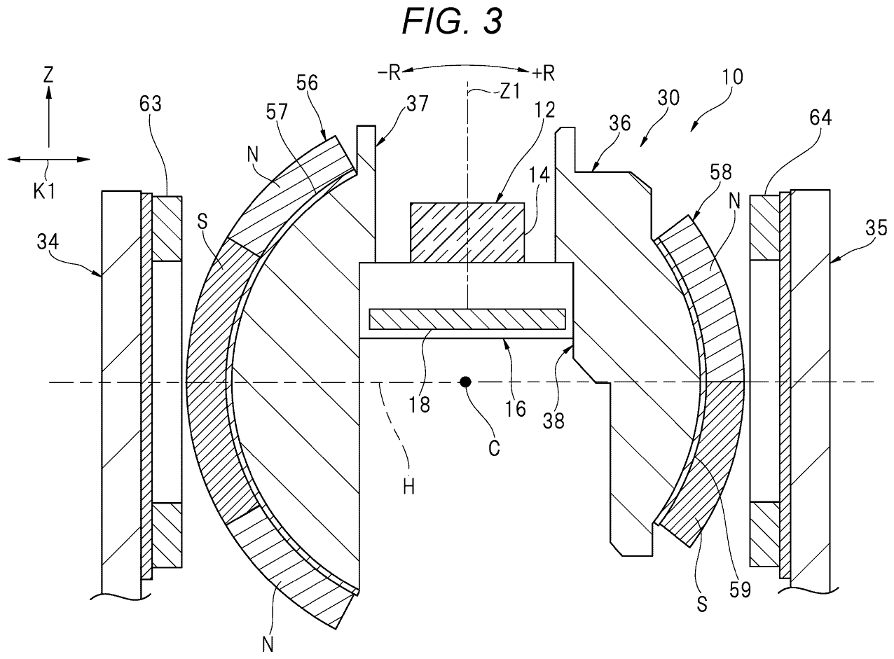

The imager 12 shown in FIG. 3 includes a lens 14 as an optical element and a body 16. The body 16 includes, for example, an image sensor 18 that captures a subject image formed by the lens 14. The imager 12 with this structure captures an image of a subject. The imager 12 has an optical axis Z1. The imager 12 is rotated in a pan direction and atilt direction by the actuator 30. The imager 12 is fixed to a compartment 38 in a holder 36 (described later). Although not described in the present embodiment, the imager 12 may include a focuser including a lens and a driver.

### Actuator

The actuator 30 shown in FIG. 3 is an example of a drive to change the angle of the imager 12 (FIG. 2). The angle of the imager 12 specifically refers to the angle of the optical axis Z1 in the pan direction and the tilt direction. The angle of the imager 12 is changed by changing the angle of the optical axis Z1 in the pan direction and the tilt direction. In this manner, the actuator 30 changes the angle of the imager 12 in the pan direction and the tilt direction.

The arrows X, Y, and Z in the figures referred to in the examples below respectively indicate the X-direction, the Y-direction, and the Z-direction. For each of the X-direction, the Y-direction, and the Z-direction, the tip of the arrow points in one direction (positive direction) and the base of the arrow points in the other direction (negative direction). In the examples described below, the directions may be referred to as the positive X-direction, the negative X-direction, the positive Y-direction, the negative Y-direction, the positive Z-direction, and the negative Z-direction.

In the present embodiment, when the imager 12 is at an initial position before rotation (hereafter referred to as a reference position), the X-direction is the pan direction, the Y-direction is the tilt direction, and the Z-direction is an optical axis direction. The relationship between the X-, Y-, and Z-directions and the pan, tilt, and optical axis directions in the present embodiment is a mere example, and is not limitative. When the imager 12 is at the reference position, the X-direction, the Y-direction, and the Z-direction are perpendicular to one another. A point at which the X-axis, the Y-axis, and the Z-axis intersect with one another is defined as a reference point C.

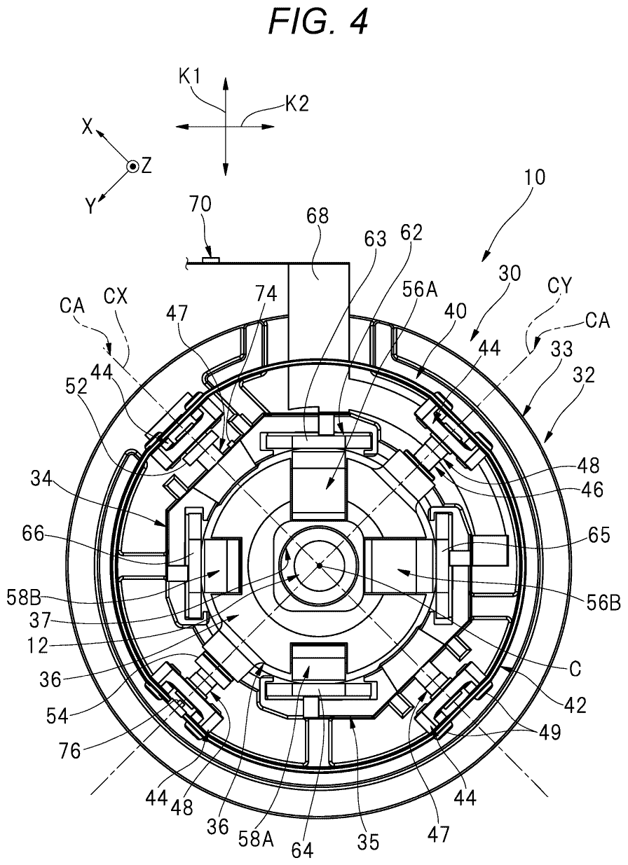

The actuator 30 shown in FIG. 4 includes, for example, a case 32, the holder 36, a support assembly 40, two first magnets 56, two second magnets 58, and a coil unit 62. The actuator 30 further includes a flexible printed circuit (FPC) 68, a driver integrated circuit (IC) 70, a first sensor 74 and a second sensor 76, and the gyro sensor 78 (FIG. 2).

### Case

As shown in FIG. 4, the case 32 includes a bottom wall 33, support walls 34 and 35, and a side wall (not shown). The bottom wall 33 is a disk having a predetermined thickness in the Z-direction. The support walls 34 and 35 stand upright from the bottom wall 33 in the positive Z-direction and face each other in the X-direction. The holder 36 (described later) is accommodated in a space surrounded by the bottom wall 33 and the support walls 34 and 35.

### Holder

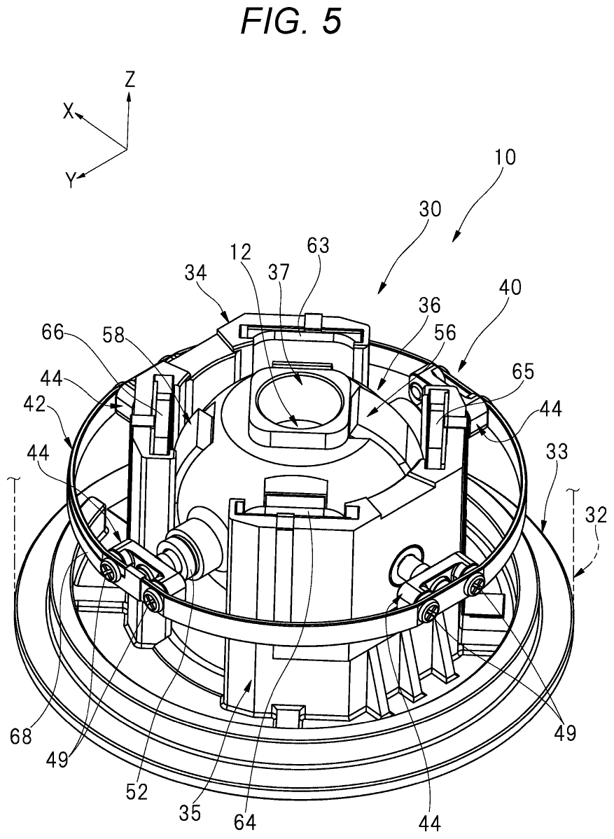

As shown in FIG. 5, the holder 36 is spherical. In the present embodiment, being spherical refers to a spherical portion that can include a non-spherical portion such as a flat portion or a curved portion. The holder 36 has an opening 37 and the compartment 38 (FIG. 3). The compartment 38 accommodates the imager 12 (FIG. 2). The holder 36 includes the two first magnets 56, two first yokes 57 (FIG. 3), the two second magnets 58, and two second yokes 59 (FIG. 3).

As shown in FIG. 3, the holder 36 has a spherical surface centered at the reference point C that is preset. In the present embodiment, for example, the rotation center of the holder 36 is at the reference point C. The rotation center of the holder 36 may not be at the reference point C. For the rotation direction of the holder 36, the clockwise rotation in the figure is referred to as a rotation in the positive R-direction, and the counterclockwise rotation in the figure is referred to as a rotation in the negative R-direction.

### Support Assembly

As shown in FIG. 4, the support assembly 40 is located inside the case 32. The support assembly 40 supports the holder 36 in a manner rotatable about the reference point C. Lines including the reference point C and extending in a direction intersecting with the radial direction of the holder 36 when the reference point C is viewed in the positive Z-direction are referred to as rotation axes CA. The support assembly 40 includes, for example, a frame 42, four bases 44, and rotational shafts 46. In the present embodiment, the rotation axes CA include a first rotation axis CX and a second rotation axis CY perpendicular to each other when the reference point C is viewed in the positive Z-direction. The first rotation axis CX extends in the X-direction. The second rotation axis CY extends in the Y-direction. Unless otherwise specified, the reference point C serves as a starting point from which the angle of the imager 12 is changed.

As shown in FIG. 5, the frame 42 has an annular shape centered at the reference point C (FIG. 4) when viewed in the Z-direction. The four bases 44 are arranged at equal intervals in the circumferential direction of the frame 42. The four bases 44 are fastened to the frame 42 with multiple screws 49.

As shown in FIG. 4, each rotational shaft 46 is located on the frame 42 in a manner rotatable about the corresponding rotation axis CA. More specifically, the rotational shafts 46 include a pair (two) of first shafts 47 rotatable about the first rotation axis CX, and a pair (two) of second shafts 48 supporting the holder 36 in a manner rotatable about the second rotation axis CY As described above, the support assembly 40 includes the frame 42, the pair of first shafts 47, and the pair of second shafts 48.

The pair of first shafts 47 and the pair of second shafts 48 are located on the four bases 44. The first shafts 47 and the second shafts 48 are non-magnetic. In the present embodiment, being non-magnetic refers to having a relative permeability less than 1.5. Being ferromagnetic refers to having a relative permeability greater than or equal to 1.5.

The pair of first shafts 47 are supported by the support walls 34 and 35 of the case 32 in a rotatable manner. The pair of second shafts 48 support the holder 36 in a rotatable manner. In other words, the pair of first shafts 47 rotate relative to the support walls 34 and 35. The pair of second shafts 48 rotate relative to the holder 36. This allows the holder 36 to rotate about the first rotation axis CX in the pan direction and about the second rotation axis CY in the tilt direction. The position of the holder 36 at which the opening 37 in the holder 36 is open in the positive Z-direction is referred to as a reference position of the actuator 30. The rotation angle of the holder 36 at the reference position is defined as 0°.

A first magnetic member 52 is fixed to the first shaft 47 in the positive X-direction. The first magnetic member 52 is annular. The direction of the magnetic force of the first magnetic member 52 changes as the first shaft 47 rotates. The magnetic force of the first magnetic member 52 is detected by the first sensor 74 (described later).

A second magnetic member 54 is fixed to the second shaft 48 in the positive Y-direction. The second magnetic member 54 is annular. The direction of the magnetic force of the second magnetic member 54 changes as the second shaft 48 rotates. The magnetic force of the second magnetic member 54 is detected by the second sensor 76 (described later).

### First Magnet

As shown in FIG. 3, each first magnet 56 is fixed to the holder 36 with the corresponding first yoke 57 between them. The first magnet 56 is located on one end in the radial direction from the reference point C. The first magnet 56 has two N poles and one S pole between the two N poles.

### Second Magnet

Each second magnet 58 is fixed to the holder 36 with the corresponding second yoke 59 between them. The second magnet 58 is located on the other end in the radial direction from the reference point C. The second magnet 58 has one N pole and one S pole. The first magnets 56 and the second magnets 58 are located asymmetric to each other with respect to the reference point C and have different lengths in the circumferential direction of the holder 36.

The direction in which a first magnet 56 and a second magnet 58 in a first set are arranged is referred to as a K1-direction. The direction in which a first magnet 56 and a second magnet 58 in a second set are arranged is referred to as a K2-direction (FIG. 4). The K1-direction and the K2-direction are perpendicular to each other. The K1-direction and the K2-direction each intersect with the X-direction and the Y-direction. The K1-direction and the K2-direction are each offset from the X-direction and the Y-direction by an angle of 45° when viewed in the Z-direction.

To distinguish the first magnet 56 and the second magnet 58 in the first set and the first magnet 56 and the second magnet 58 in the second set, the first magnet 56 and the second magnet 58 in the first set are referred to as a first magnet 56A and a second magnet 58A, and the first magnet 56 and the second magnet 58 in the second set are referred to as a first magnet 56B and a second magnet 58B. The first magnet 56A and the second magnet 58A are arranged in the K1-direction. The first magnet 56B and the second magnet 58B are arranged in the K2-direction.

### Coil Unit

As shown in FIG. 4, the coil unit 62 is located on the support walls 34 and 35 of the actuator 30. The coil unit 62 includes a first coil 63, a second coil 64, a third coil 65, and a fourth coil 66. The first coil 63 and the second coil 64 are spaced from each other in the K1-direction. The third coil 65 and the fourth coil 66 are spaced from each other in the K2-direction. The coil unit 62 faces the first magnets 56 and the second magnets 58 in the radial direction of the holder 36. Thus, the coil unit 62 is energized to generate magnetic fields that act on the first magnets 56 and the second magnets 58.

As shown in FIG. 3, a line including the reference point C and extending in the K1-direction is referred to as an imaginary line H. One S pole of the first magnet 56 extends in the negative Z-direction and the positive Z-direction across the imaginary line H in the R-direction. The second magnet 58 has a boundary surface (polarizing surface) between the N pole and the S pole on the imaginary line H. In the actuator 30, the components are arranged in the K2-direction in the same manner as in the K1-direction. The components in the K2-direction will not be described.

### Flexible Printed Circuit (FPC)

As shown in FIG. 4, the FPC 68 is placed from outside the case 32 into the case 32 and extends along the bottom wall 33. The driver IC 70 (described later) is mounted on and connected to a part of the FPC 68. The FPC 68 branches on the bottom wall 33 and is electrically connected to the coil unit 62, the first sensor 74, and the second sensor 76.

### Driver IC

The driver IC 70 shown in FIG. 4 drives the coil unit 62 to rotate the holder 36 about the first rotation axis CX and the second rotation axis CY The rotation of the holder 36 will be described later. The driver IC 70 is electrically connected to the controller 20 (FIG. 2).

### Detector

The detector 72 detects the angle (the pan angle and the tilt angle) of the imager 12. Information about the angle of the imager 12 detected by the detector 72 is transmitted to the controller 20 (FIG. 2). The detector 72 includes the first sensor 74 and the second sensor 76.

The first sensor 74 is a tunnel magneto resistance (TMR) sensor. The first sensor 74 is located on the support wall 34. The first sensor 74 detects the rotational position of the holder 36 about the first rotation axis CX by detecting the direction of the magnetic force of the first magnetic member 52.

The second sensor 76 is a TMR sensor. The second sensor 76 is located on the frame 42. The second sensor 76 detects the rotational position of the holder 36 about the second rotation axis CY by detecting the direction of the magnetic force of the second magnetic member 54. Information about the rotational position of the holder 36 about the first rotation axis CX and information about the rotational position of the holder 36 about the second rotation axis CY are converted into information about the angle in the pan direction and the angle in the tilt direction.

### Gyro Sensor

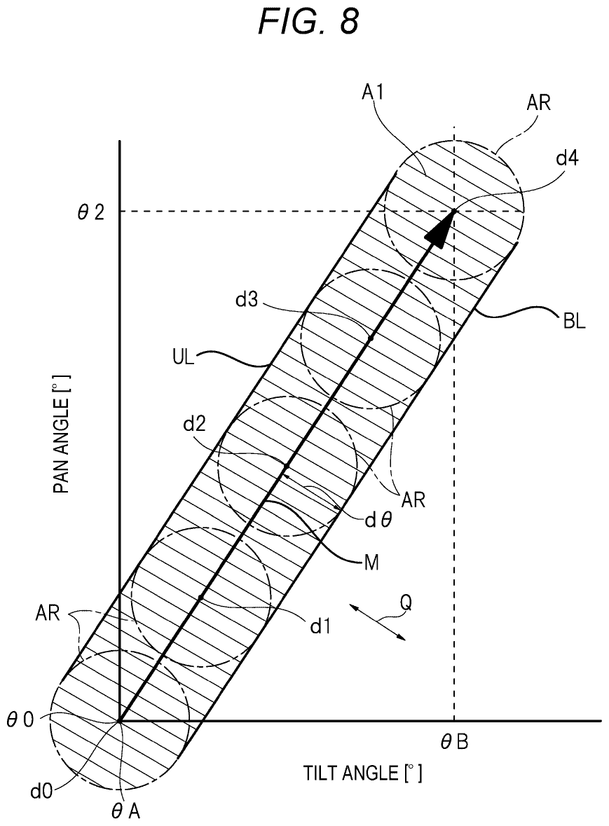

The gyro sensor 78 shown in FIG. 2 is an example of an obtainer to obtain information about the deviation angle of the imager 12 from its reference angle. The reference angle of the imager 12 refers to an angle of an imaginary line in the pan direction and an angle of the imaginary line in the tilt direction. The imaginary line is a line connecting the center of the imager 12 and the center of a subject (a subject in a stationary state) that is an imaging target with the center of the imager 12 defined as an origin (starting point). In the examples described below, the imaginary line is referred to as a reference line M (FIG. 8) representing a reference angle.

In the present embodiment, for example, the center of the imager 12 is at the reference point C (FIG. 3). The center of the imager 12 refers to the center of the holder 36 (FIG. 3) including the imager 12. The center of the imager 12 may be set at the center position of the image sensor 18 or the position of the center of gravity of the image sensor 18. The center of a subject refers to the center of a portion of the subject imaged by the imager 12. For example, when the subject is a human and the face is imaged, the center of the subject refers to the center of the face. When the entire body is imaged, the center of the subject refers to the center of the body.

The gyro sensor 78 detects the angular velocity of the actuator 30 (optical device 10). The angular velocity detected by the gyro sensor 78 is integrated to calculate deviation angles (angle deviations) in the pan direction and the tilt direction. The obtained angular velocity may be integrated by the gyro sensor 78 or by the CPU 22.

A deviation angle obtained by the gyro sensor 78 can be determined as the deviation angle of the imager 12 based on disturbance in an intersecting direction intersecting with the reference line M (described later) in changing the angle of the imager 12. The intersecting direction is not limited to a direction that forms a right angle with the reference line M, and may be a direction intersecting with the reference line M at an angle other than a right angle.

For example, the deviation angle (with components in the pan direction and the tilt direction) of the imager 12 from the reference line M may be a deviation angle θα (°) during driving of the holder 36 (FIG. 3) with the actuator 30 to cause the imager 12 to be at an angle on the reference line M. The deviation angle (the deviation angle based on disturbance such as vibrations) obtained by the gyro sensor 78 may be a deviation angle θβ (°). In this case, the actual deviation angle dθ of the imager 12 from the reference line M is expressed as dθ=θα+θβ. The actuator 30 then changes, based on a command input through the controller 20, the angle of the imager 12 toward the reference line M, possibly decreasing the deviation angle dθ to 0°. The deviation angle θα and the deviation angle θβ are not shown in the figures.

### Rotation of Holder

In the actuator 30 shown in FIG. 4, in response to the coil unit 62 being energized, thrust may act on the first magnet 56A and the second magnet 58B in the negative Z-direction and on the first magnet 56B and the second magnet 58A in the positive Z-direction. In this case, the holder 36 rotates in one direction about the second rotation axis CY. When the thrust acts in the opposite directions, the holder 36 rotates in the other direction about the second rotation axis CY In other words, the imager 12 and the holder 36 rotate in the tilt direction.

In response to the coil unit 62 being energized, thrust may act on the first magnet 56A and the first magnet 56B in the positive Z-direction and on the second magnet 58A and the second magnet 58B in the negative Z-direction. In this case, the holder 36 rotates in one direction about the first rotation axis CX. When the thrust acts in the opposite directions, the holder 36 rotates in the other direction about the first rotation axis CX. In other words, the imager 12 and the holder 36 rotate in the pan direction. In this manner, the actuator 30 changes the angle of the imager 12 in the pan direction and the tilt direction. The angle of the imager 12 has components in both the pan direction and the tilt direction perpendicular to each other.

### Control of Optical Device Using Communication Terminal

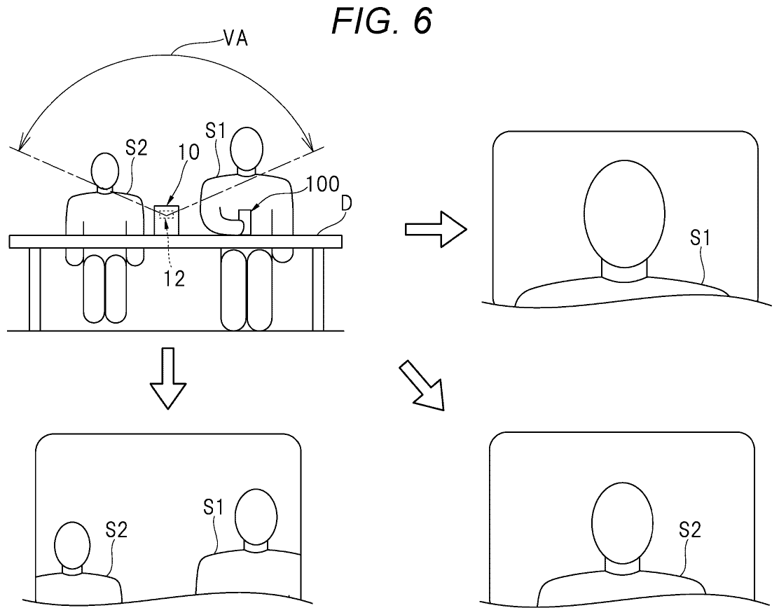

As shown in FIG. 6, the optical device 10 is placed on the top of a desk D. The optical device 10 is supported on a support plate (not shown). For example, the first subject S1 and the second subject S2 are in the range of an angle of view VA of the imager 12. The imager 12 is oriented at the reference angle that is preset.

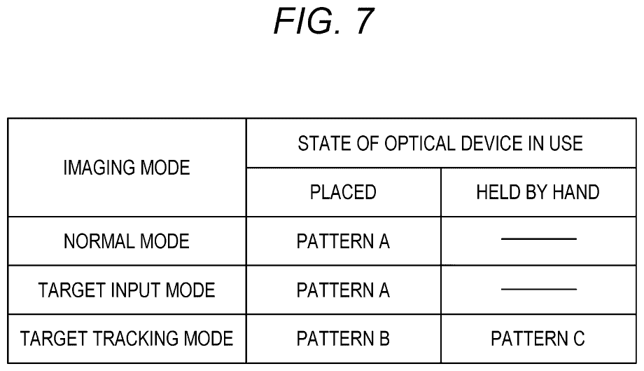

FIG. 7 collectively shows control patterns of the optical device 10 (FIG. 2) in a table. The control patterns of the optical device 10 are each determined by a combination of an imaging mode that can be set in the communication terminal 100 (FIG. 2) and the state of the optical device 10 in use. The control patterns are, for example, a pattern A, a pattern B, and a pattern C. The pattern A is a control pattern used when a normal mode or a target input mode (described later) is selected with the optical device 10 placed on the desk D (FIG. 6).

The pattern B is a control pattern used when a target tracking mode (described later) is selected with the optical device 10 placed on the desk D. The pattern C is a control pattern used when the target tracking mode is selected with the optical device 10 held by hand. For example, the normal mode or the target input mode is not selected with the optical device 10 held by hand. In the first embodiment, the control pattern is the pattern A. The pattern B and the pattern C will be described in the second and subsequent embodiments.

### Reference Line and Allowable Range

FIG. 8 shows the reference line M used when the angle of the imager 12 (FIG. 3) is changed from an initial angle d0 to a target angle d4. The angle of the imager 12 corresponds to the orientation of the imager 12 determined by the angle of the imager 12 in the tilt direction (tilt angle) and the angle of the imager 12 in the pan direction (pan angle). The initial angle d0 refers to a tilt angle θA (°) and a pan angle θ0 (°) when the imager 12 has an orientation that serves as a reference before the orientation of the imager 12 is changed. The target angle d4 refers to a tilt angle θB (°) and a pan angle θ2 (°) when the imager 12 reaches an orientation at which the imager 12 can capture an image of a specified subject.

The reference line M is an imaginary line connecting, in response to a subject being specified, the center of the imager 12 and the center of the subject. The reference line M is the shortest straight line connecting the coordinates of the initial angle dθ and the coordinates of the target angle d4. The reference line M represents a reference angle that serves as a reference for control in changing the angle of the imager 12. In other words, the reference line M represents changes in the tilt angle and changes in the pan angle in controlling the operation of the actuator 30 (FIG. 3).

The reference line M indicates angles d1, d2, and d3 each representing the angle of the imager 12 during change of the angle of the imager 12 from the initial angle dθ to the target angle d4. The operation of the actuator 30 (FIG. 3) is controlled along the reference line M, thus changing the tilt angle and the pan angle of the imager 12. This allows the imager 12 to be oriented toward the subject.

When the actuator 30 operates based on the reference line M, the angle of the imager 12 changes in the order of the initial angle d0, the angle d1, the angle d2, the angle d3, and the target angle d4 over time. In FIG. 8, the intersecting direction intersecting with the reference line M is indicated by an arrow Q. The amount of deviation from the reference line M in the intersecting direction represents the amount of deviation of the angle of the imager 12, or in other words, the deviation angle of the imager 12. The angle between the intersecting direction and the reference line M is not limited to a right angle and may be another angle.

The deviation angle of the imager 12 from the reference line M is denoted with dθ (°). In the present embodiment, thresholds (°) of the deviation angle dθ including measurement errors are predetermined. For example, the same threshold of the deviation angle dθ is set for each angle from the initial angle d0 to the target angle d4. In FIG. 8, a circle AR having a radius being the threshold of the deviation angle dθ is indicated. The deviation angle dθ being within the circle AR refers to the deviation angle dθ being within an allowable range.

A range through which the circle AR passes along the reference line M (a range hatched with diagonal lines) is defined as an allowable range A1 of the deviation angle dθ of the imager 12. The allowable range A1 indicates a range of allowable deviation angles from the reference line M for the tilt angle and the pan angle. Aline segment in the allowable range A1 indicating the lower limit is defined as a boundary BL. A line segment in the allowable range A1 indicating the upper limit is defined as a boundary UL. In other words, the allowable range A1 is a range between the boundary BL and the boundary UL.

### Effects of Components in First Embodiment

A method for controlling the optical device 10 will now be described with reference to the flowchart shown in FIG. 9. For the components of the optical device 10 (FIG. 2) and the communication terminal 100 (FIG. 2), FIGS. 1 to 5 are to be referred to, and the figure numbers are not individually referred to. The processes shown in FIG. 9 are performed by the CPU 104 that loads and executes a program (not shown) after reading the program from the memory 106. For example, the program starts in response to a subject being set by the user operating the communication terminal 100. The angle of the imager 12 is then changed to cause the center of the set (selected) subject to be at the center of the display panel 108.

In the overall processing in the flowchart, the angle of the imager 12 is set as the initial angle d0, and then the target angle d4 is set. When any deviation angle occurs in the angle of the imager 12 in changing the angle of the imager 12 from the initial angle d0 to the target angle d4 after the operation of the actuator 30 is started, correction of the deviation angle is performed. The deviation angle (image blur) of the imager 12 may occur with, for example, earthquake vibrations received by the optical device 10 or camera shake from the user holding the optical device 10 by hand. In response to the angle of the imager 12 falling within the allowable range of the target angle d4 (being less than the set threshold), the program ends.

In FIG. 9, the actuator 30 is abbreviated as ACT. In the flowcharts in the figures other than FIG. 9 as well, the actuator 30 is abbreviated as ACT. A target refers to a subject to be imaged. The actuator 30 changes the angle of the imager 12 within a physically limited range. The upper limit value of the target angle d4 is thus set to, for example, an angle of 37.5°. The upper limit value of the target angle d4 may be set to an angle other than 37.5°. An ACT angle refers to the tilt angle and the pan angle of the imager 12.

In step S10, the CPU 104 transmits command information to the driver IC 70 through the controller 20 to turn on a servo in the actuator 30. The processing then advances to step S12.

In step S12, the CPU 104 detects the angle of the actuator 30 (the pan angle and the tilt angle of the imager 12) based on detection information from the detector 72. The processing then advances to step S14.

In step S14, the CPU 104 determines whether the difference between the detected angle of the actuator 30 and the initial angle d0 is less than or equal to 1°. When the difference between the angle of the actuator 30 and the initial angle d0 is less than or equal to 1° (Yes in S14), the CPU 104 determines that the angle of the actuator 30 is the initial angle d0 and advances the processing to step S16. When the difference between the angle of the actuator 30 and the initial angle d0 is greater than 1° (No in S14), the processing advances to step S18.

In step S16, the CPU 104 starts detecting the deviation angle dθ from the reference line M using the gyro sensor 78. The processing then advances to step S20.

In step S18, the CPU 104 causes the actuator 30 to operate to cause the difference between the angle of the actuator 30 and the initial angle dθ to be less than or equal to 1°. More specifically, the CPU 104 changes the states of the first coil 63, the second coil 64, the third coil 65, and the fourth coil 66 energized by the driver IC 70 to change the angle of the imager 12. The processing then advances to step S12.

In step S20, the CPU 104 specifies a target based on information specified (set) on the display panel 108 by a user (target S). In this example, the first subject S1 is specified, for example. The processing then advances to step S22. Step S20 is an example of specifying a subject.

In step S22, the CPU 104 obtains information about the target angle d4. For example, the CPU 104 obtains information about the orientation (the tilt angle and the pan angle) of the first subject S1 relative to the center of the imager 12 based on the positional information of the first subject S1 on the display panel 108. More specifically, a data table for the relationship between the position of a target appearing on the display panel 108 and the orientation of the first subject S1 is stored into the memory 106, and the CPU 104 compares the positional information of the target with the information in the data table to obtain the orientation of the first subject S1. The processing then advances to step S24.

In step S24, the CPU 104 determines whether the target angle d4 is less than or equal to 37.5° that is an upper limit angle. When the target angle d4 is less than or equal to 37.5° (Yes in S24), the processing advances to step S26. When the target angle d4 is greater than 37.5° (No in S24), the processing advances to step S28. The target angle d4 being less than or equal to 37.5° refers to both the tilt angle and the pan angle being less than or equal to 37.5°.

In step S26, the CPU 104 sets the target angle d4 in the memory 24 in the optical device 10. The processing then advances to step S30.

In step S28, the CPU 104 sets the target angle d4 as 37.5° in the memory 24 in the optical device 10. The processing then advances to step S30.

In step S30, the CPU 104 defines the reference line M associated with the tilt angle and the pan angle based on information about the initial angle dθ and the information about the target angle d4. The processing then advances to step S32. Step S30 is an example of defining, in response to the first subject S1 being specified, an imaginary line connecting the center of the imager 12 and the center of the first subject S1 as the reference line M representing the reference angle.

In step S32, the CPU 104 generates a data table of the allowable range A1 (thresholds) of the deviation angle dθ. More specifically, the CPU 104 creates a table of combinations of the values of the tilt angle and the values of the pan angle, and then determines, for the created table, combinations of thresholds corresponding to the boundaries BL and UL. The CPU 104 can thus determine whether the angle of the imager 12 is within the allowable range A1 based on the thresholds. The processing then advances to step S34. Step S32 is an example of setting a threshold of the deviation angle dθ from the reference angle of the imager 12 in the intersecting direction intersecting with the reference line M.

In step S34, the CPU 104 starts the operation of the actuator 30. More specifically, the CPU 104 causes the actuator 30 to operate (a current to flow through the coils) to change the angle of the imager 12 from the initial angle dθ to the target angle d4 along the reference line M. Step S34 is an example of starting an operation of changing, with the actuator 30, the angle of the imager 12 along the reference line M. The processing then advances to step S36.

In step S36, the CPU 104 determines whether the difference between the tilt angle detected by the detector 72 and the tilt angle of the target angle d4 and the difference between the pan angle detected by the detector 72 and the pan angle of the target angle d4 (collectively referred to as an angular difference) are each greater than 1°. When the angular difference is greater than 1° (Yes in S36), the CPU 104 determines that the imager 12 has yet to reach the target angle d4 and advances the processing to step S38. When the angular difference is less than or equal to 1° (No in S36), the CPU 104 determines that the imager 12 has reached the target angle d4 and ends the program.

In step S38, the CPU 104 obtains the information about the tilt angle and the information about the pan angle (deviation angle dθ1) detected by the detector 72, and obtains, from the gyro sensor 78, information about the tilt angle and the pan angle (deviation angle dθ2). The total deviation angle dθ is expressed as dθ=dθ1+dθ2. The deviation angle dθ1 and the deviation angle d62 are not shown in the figures. Step S38 is an example of obtaining, with the gyro sensor 78, the information about the deviation angle d62 in the intersecting direction. The processing then advances to step S40.

In step S40, the CPU 104 determines whether the deviation angle dθ is greater than the threshold based on information about the total deviation angle dθ obtained in step S38. More specifically, the CPU 104 compares the value of the total deviation angle dθ with the corresponding threshold in the generated table. When the total deviation angle dθ is greater than the threshold (Yes in S40), the processing advances to step S42. When the total deviation angle dθ is less than or equal to the threshold (No in S40), the processing advances to step S34.

In step S42, the CPU 104 sets deviation angle reduction information in the driver IC 70 through the controller 20. More specifically, the CPU 104 sets, in the driver IC 70, the amount of movement of the actuator 30 (the amount of change in the angle of the imager 12) to cause the total deviation angle dθ to be less than or equal to the threshold. The processing then advances to step S34. Steps S40 and S42 are examples of changing, with the actuator 30, the angle of the imager 12 until the deviation angle dθ in the intersecting direction falls below the threshold in response to the deviation angle dθ in the intersecting direction exceeding the threshold in changing, with the actuator 30, the angle of the imager 12 along the reference line M. Further, step S34 is an example of continuing the operation of changing, with the actuator 30, the angle of the imager 12 along the reference line M after the deviation angle dθ in the intersecting direction falls below the threshold.

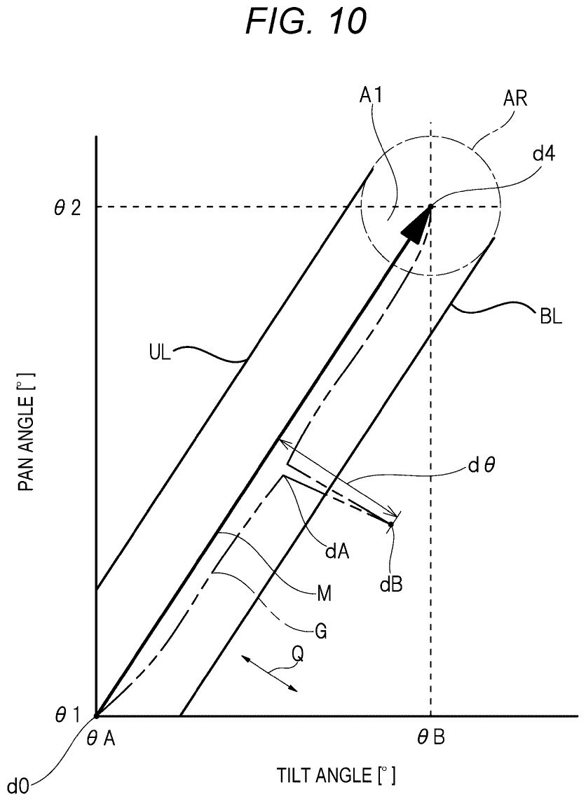

FIG. 10 shows the deviation angle dθ exceeding the allowable range A1 (the thresholds: the boundary BL) during change of the orientation of the imager 12 (FIG. 2) to the target angle d4 based on the reference line M. In FIG. 10, the actual changes in the angle of the imager 12 are indicated by an imaginary line G. The angle of the imager 12 is within the allowable range A1 along the reference line M until the imager 12 reaches an angle dA. However, when the optical device 10 (FIG. 2) receives, for example, vibrations with the imager 12 being at the angle dA, the deviation angle dθ increases, causing the angle of the imager 12 to be an angle dB exceeding the allowable range A1.

In response to the deviation angle dθ exceeding the allowable range A1, the actuator 30 (FIG. 2) changes (corrects) the tilt angle and the pan angle of the imager 12 to cause the deviation angle dθ of the imager 12 to fall within the allowable range A1. The angle of the imager 12 is thus within the allowable range A1 again as indicated by the imaginary line G, reducing the deviation angle of the imager 12 from the reference line M. The actuator 30 then continues the operation of changing the angle of the imager 12 to the target angle d4.

As described above, the method for controlling the optical device 10 according to the first embodiment defines the reference line M connecting the center of the imager 12 and the center of the first subject S1 (the center of the selection frame FR) in response to the first subject S1 being specified on the display panel 108. Further, the threshold of the deviation angle dθ of the imager 12 in the intersecting direction intersecting with the reference line M and the allowable range A1 are set. The actuator 30 then changes the angle of the imager 12 (the direction of the optical axis Z1) based on the reference line M. When the deviation angle dθ obtained from the detector 72 and the gyro sensor 78 is within the allowable range A1, or in other words, when small vibrations occur in the optical device 10, the operation of the actuator 30 is continued and the angle of the imager 12 reaches the target angle d4. The imager 12 is thus oriented toward the first subject S1. An image of the first subject S1 thus appears at a center portion of the display panel 108 when imaging is performed with the imager 12.

When the deviation angle dθ obtained from the detector 72 and the gyro sensor 78 exceeds the threshold and thus the angle of the imager 12 exceeds the allowable range A1, or in other words, when large vibrations occur in the optical device 10, the angle of the imager 12 is changed to reduce the deviation angle dθ. The angle of the imager 12 then continues to be changed based on the reference line M. In other words, the actuator 30 changes the angle of the imager 12 until the angle of the imager 12 falls within the allowable range A1. Thus, under large vibrations in the optical device 10, the actuator 30 can cause the angle of the imager 12 to reach the target angle d4 while reducing a deviation that affects the image. An image of the first subject S1 thus appears at the center portion of the display panel 108 when imaging is performed with the imager 12.

As described above, when vibrations occur in the optical device 10 in which imaging is performed with the imager 12 oriented toward the first subject S1, the imager 12 can be oriented toward the first subject S1 independently of the vibration level. This can reduce image blur that may occur with vibrations received by the optical device 10 in changing the angle of the imager 12 toward the first subject S1.

The method for controlling the optical device 10 according to the first embodiment causes the actuator 30 to drive the imager 12 to an angle (orientation) having a component in the pan direction and a component in the tilt direction, and thus can change the angle of the imager 12 in the pan direction and the tilt direction.

### Components in Second Embodiment

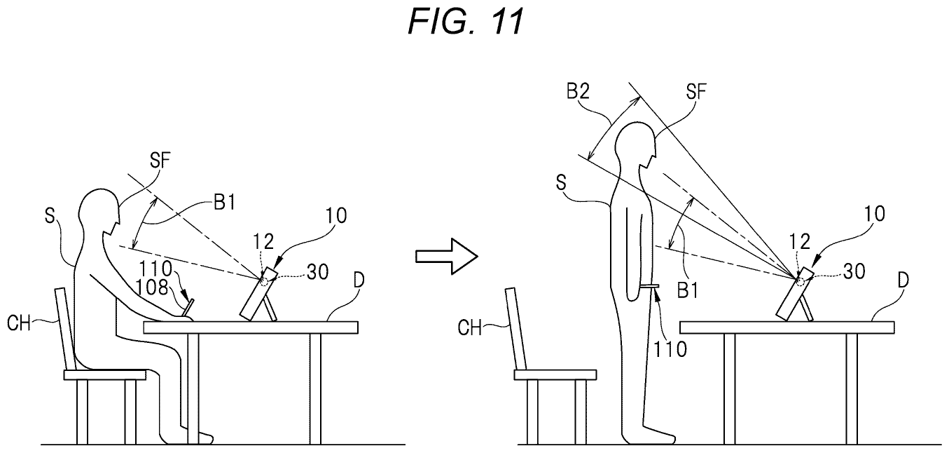

FIG. 11 shows an optical device 10 according to a second embodiment with the imager 12 changing its angle by following the motion of the subject S. The second embodiment differs from the first embodiment in the method for controlling the optical device 10. The same components as in the first embodiment are denoted with the same reference numerals and will not be described.

The subject S is seated on a chair CH. The optical device 10 is placed on the desk D. A face SF of the subject S faces the imager 12. A range B1 represents an imaging range in which the imager 12 can capture an image of the entire face SF with the subject S seated on the chair CH. A range B2 represents an imaging range in which the imager 12 can capture an image of the entire face SF with the subject S standing up from the chair CH.

The optical device 10 operates by transmitting and receiving information to and from a communication terminal 110. The angle of the imager 12 in the optical device 10 is changed by, for example, the subject S operating the communication terminal 110. In the present embodiment, the face SF is identified when the subject S is seated. When the subject S stands up, the imager 12 tracks the face SF as the face SF of the subject S moves.

### Communication Terminal

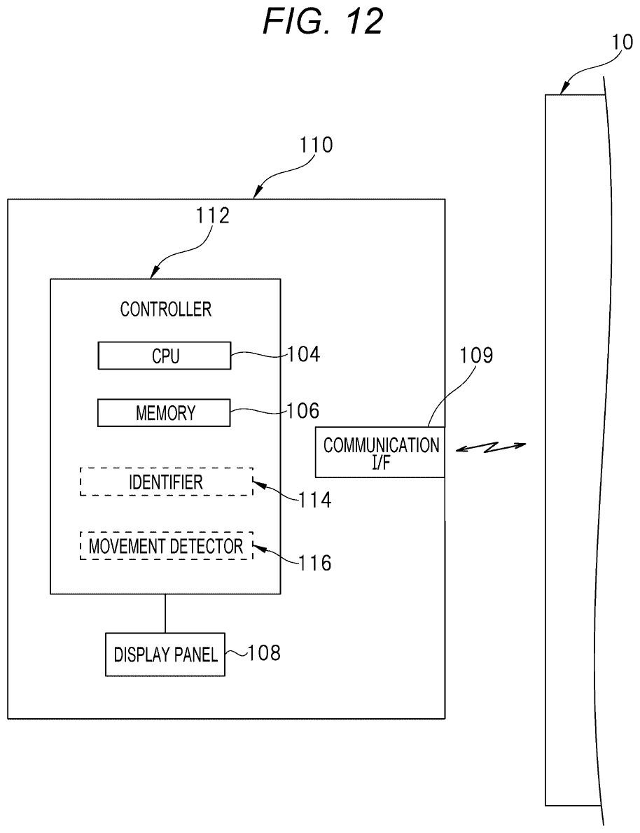

As shown in FIG. 12, the communication terminal 110 includes a controller 112, the display panel 108, and the communication I/F 109. The controller 112 includes the CPU 104 and the memory 106. Further, the controller 112 includes an identifier 114 and a movement detector 116 as functional components. In the controller 112, the CPU 104 executes a program stored in the memory 106 to implement the functions of the identifier 114 and the movement detector 116.

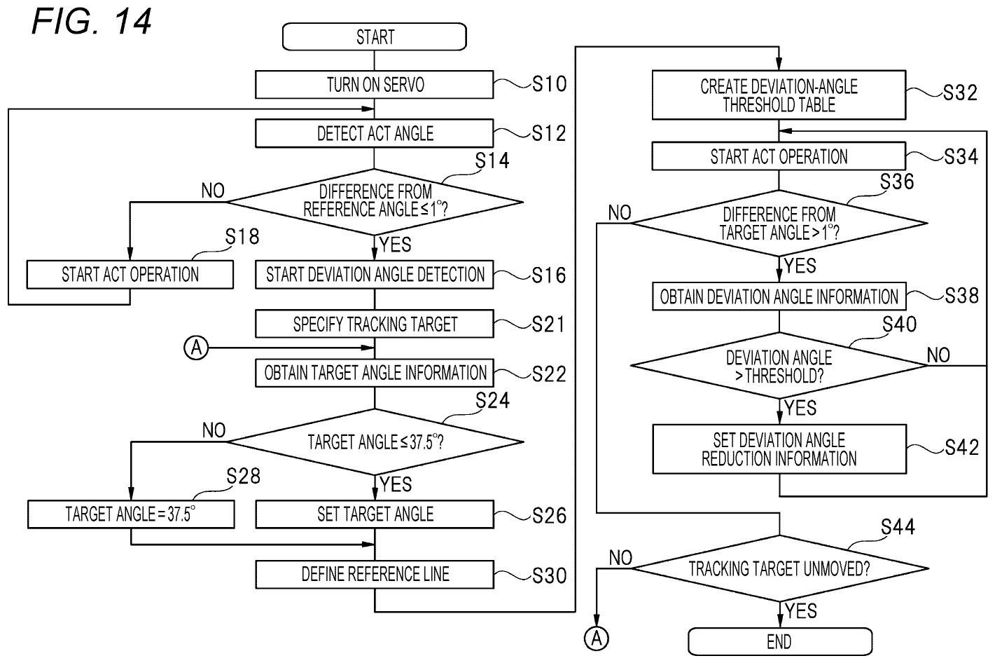

The controller 112 may include separate hardware modules as the identifier 114 and the movement detector 116. The processes performed with the program in the controller 112 will be described later with reference to a flowchart (FIG. 14).

### Identifier

The controller 112 obtains, using a known face recognition technique, information about the face SF of the subject S based on an image captured with the imager 12 (FIG. 11) and stores the information into the identifier 114. The identifier 114 compares the face SF (FIG. 11) specified by the subject S operating the display panel 108 with the prestored information about the face SF to identify the face SF specified by the subject S as the subject S or another person.

### Movement Detector

The movement detector 116 detects movement of the identified subject S from a first position to a second position. More specifically, the movement detector 116 determines whether the center position of the face SF identified by the identifier 114 changes over time in the image to detect any movement of the subject S from the first position to the second position.

### Reference Line and Allowable Range

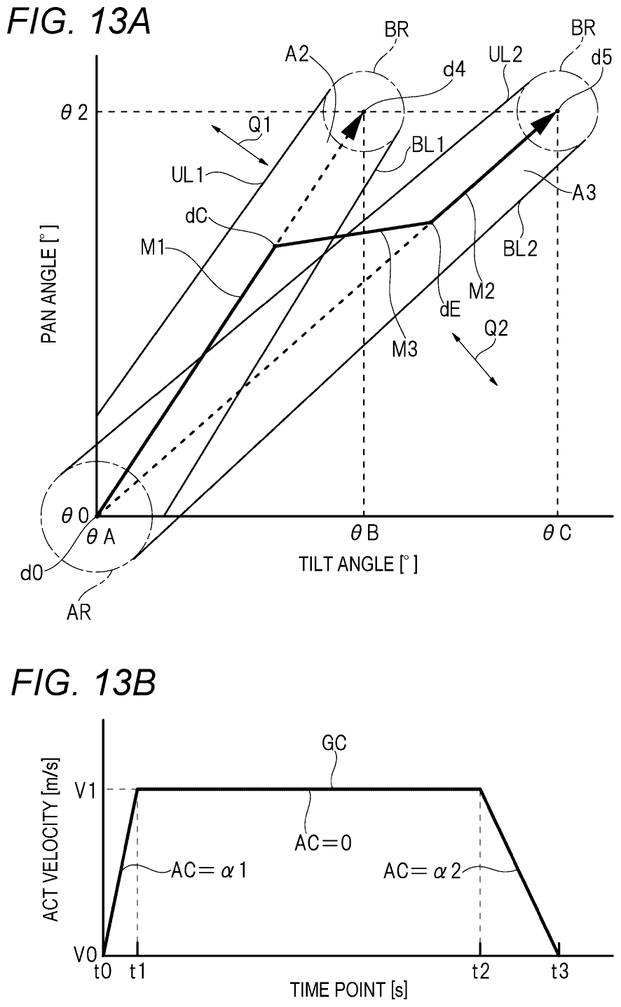

FIG. 13A shows a reference line M1 used when the angle of the imager 12 (FIG. 11) is changed from the initial angle dθ to the target angle d4 and a reference line M2 used when the angle of the imager 12 is changed from the initial angle dθ to a target angle d5. The reference line M2 is an example of a new reference line.

The target angle d5 refers to a tilt angle θC (°) and a pan angle θ2 (°). The pan angle for both the target angles d4 and d5 is the pan angle θ2. In other words, when changing the angle of the imager 12 from the target angle d4 to the target angle d5 as the face SF (FIG. 11) moves, the actuator 30 (FIG. 2) changes the tilt angle from θB to θC while maintaining the pan angle at θ2.

In FIG. 13A, an intersecting direction intersecting with the reference line M1 is indicated by an arrow Q1. A direction intersecting with the reference line M2 is indicated by an arrow Q2. In FIG. 13A, in response to the subject S (FIG. 11) standing up, the target angle is changed from d4 to d5 before the imager 12 (FIG. 11) reaches the target angle d4. For example, the reference line is switched from M1 to M2 from the time point at which the imager 12 reaches an angle dC on the reference line M1 to the time point at which the imager 12 reaches an angle dE on the reference line M2. The reference for the angle of the imager 12 in switching the reference line from M1 to M2 is indicated by a reference line M3. The angle of the imager 12 is changed along the reference line M2 and to the target angle d5 after the reference line is switched from M3 to M2 at the angle dE.

At the initial angle d0, an allowable range of a deviation angle (an example of an imager threshold) is indicated by the circle AR. At each of the target angles d4 and d5, the allowable range of the deviation angle (an example of a subject threshold) is indicated by a circle BR. The circle BR has a smaller radius than the circle AR. In other words, thresholds include the subject threshold and the imager threshold set for an area closer to the imager 12 than the subject threshold. The subject threshold is less than the imager threshold.

The lower limits of the thresholds for the reference line M1 are indicated by a boundary BL1. The upper limits of the thresholds are indicated by a boundary UL1. The range between the boundary BL1 and the boundary UL1 is defined as an allowable range A2 of the deviation angle. Similarly, the lower limits of the thresholds for the reference line M2 are indicated by a boundary BL2. The upper limits of the thresholds are indicated by a boundary UL2. The range between the boundary BL2 and the boundary UL2 is defined as an allowable range A3 of the deviation angle. For example, the allowable ranges A2 and A3 are both set to continuously narrow as the angle of the imager 12 is closer to the target angles d4 and d5. Boundaries corresponding to the reference line M3 are defined but not shown in the figure.

### Acceleration Setting

FIG. 13B is a graph GC showing changes in an ACT velocity (m/s) at time points (s). The ACT velocity refers to the velocity at which the actuator 30 (FIG. 11) operates and corresponds to the velocity at which the angle of the imager 12 (FIG. 11) changes. The change of the ACT velocity with time is defined as an acceleration AC (m/s²) of the imager 12. A data table of the graph GC is prestored in the memory 106 (FIG. 12).

In the graph GC, the ACT velocity is V0 (=0) at a time point t0 at which the actuator 30 starts operating. The ACT velocity increases from V0 to V1 from the time point t0 to a time point t1. For example, the ACT velocity is maintained at V1 from the time point t1 to a time point t2. The ACT velocity decreases from V1 to V0 from the time point t2 to a time point t3. For example, the time from the time point t0 to the time point t1 is shorter than the time from the time point t2 to the time point t3.

The data table of the graph GC is set to satisfy α1>α2, where the acceleration AC from the time point t0 to the time point t1 is α1, the acceleration AC from the time point t1 to the time point t2 is zero (a constant velocity), and the acceleration AC from the time point t2 to the time point t3 is α2. At the time point t3, the angle of the imager 12 reaches the target angle d5 (FIG. 13A). As described above, the acceleration AC of the actuator 30 changing the angle of the imager 12 is set smaller when the angle of the imager 12 is closer to the target angles d4 and d5 (closer to the reference lines M1 and M2).

### Effects of Components in Second Embodiment

A method for controlling the optical device 10 according to the second embodiment will now be described with reference to the flowchart shown in FIG. 14. For the components of the optical device 10 (FIG. 11) and the communication terminal 100 (FIG. 12), FIGS. 1 to 5 and FIGS. 11 to 13B are to be referred to, and the figure numbers are not individually referred to. The same effects as in the first embodiment will not be described.

The processes shown in FIG. 14 are performed by the CPU 104 that loads and executes a program (not shown) after reading the program from the memory 106. For example, the program starts in response to the subject S operating the communication terminal 110 to set (perform face authentication on) the face SF of the subject S. The angle of the imager 12 is then changed to cause the set face SF to be at the center portion of the display panel 108.

The same steps as in the first embodiment are denoted with the same reference numerals and will not be described. More specifically, unlike in the flowchart (FIG. 9) in the first embodiment, step S21 is set in place of step S20, and step S44 is added.

In step S21 subsequent to step S16, the CPU 104 performs, with the identifier 114, face authentication on the face SF of the subject S specified by the subject S on the display panel 108. In this example, the face SF of the subject S is identified based on the result of face authentication performed with the identifier 114. In this manner, the subject S as a tracking target is specified in step S21. The processing then advances to step S22. Step S21 is included in an example of identifying the subject S with the identifier 114 in response to the subject S being specified.

In step S22, when the specified subject S is seated on the chair CH, the CPU 104 obtains information about the target angle d4. When the specified subject S is standing, the CPU 104 obtains information about the target angle d5. The processing then advances to step S24.

In step S26, when the specified subject S is seated on the chair CH, the CPU 104 sets the target angle d4. When the specified subject S is standing, the CPU 104 sets the target angle d5. The processing then advances to step S30.

In step S30, when the target angle d4 is set, the CPU 104 defines the reference line M1 associated with the tilt angle and the pan angle based on information about the initial angle d0 and the information about the target angle d4. Step S30 is an example of defining, in response to the subject S being at a first position (a seated position: the target angle d4), an imaginary line connecting the center of the imager 12 and the first position as the reference line M1 before the movement.

In step S30, when the target angle d5 is set, the CPU 104 defines the reference line M2 associated with the tilt angle and the pan angle based on the information about the initial angle d0 and the information about the target angle d5. In other words, step S30 is also an example of defining, in response to the movement detector 116 detecting movement of the subject S to a second position (a standing position: the target angle d5), an imaginary line connecting the center of the imager 12 and the second position as the new reference line. The processing then advances to step S32.

In step S32, for the target angle d4, the CPU 104 generates a data table of the allowable range A2 (thresholds) of the deviation angle d0. For the target angle d5, the CPU 104 generates a data table of the new allowable range A3 (new thresholds) of the deviation angle d0. Step S32 is an example of setting, in response to the subject S being at the second position, a new threshold corresponding to the new reference line (reference line M2). The processing then advances to step S34.

In step S34, the CPU 104 starts the operation of the actuator 30. More specifically, the CPU 104 causes the actuator 30 to operate to change the angle of the imager 12 from the initial angle d0 to the target angle d4 along the reference line M1. The CPU 104 also causes the actuator 30 to operate to change the angle of the imager 12 from the initial angle d0 to the target angle d5 along the reference line M2. Step S34 is an example of changing the angle of the imager 12 along the new reference line. The processing then advances to step S36.

In step S36, when the difference between the target angle d4 and the current angle (orientation) of the imager 12 is less than or equal to 1° (No in S36), the CPU 104 advances the processing to step S44. When the angular difference is greater than 1° (Yes in S36), the CPU 104 determines that the imager 12 has yet to reach the target angle d4 and advances the processing to step S38.

Steps S40 and S42 are examples of changing, with the actuator 30, the angle of the imager 12 until the deviation angle falls below the new thresholds in response to the deviation angle exceeding the new thresholds in changing, with the actuator 30, the angle of the imager 12 and continuing an operation of changing, with the actuator 30, the angle of the imager 12 along the new reference line after the deviation angle falls below the new thresholds.

In step S44, the CPU 104 determines whether the position of the subject S (target angle) detected by the movement detector 116 is the same as the target angle obtained in step S22. In other words, the CPU 104 determines whether the position of the face SF in the image captured by the imager 12 is the same as its position at the time when step S22 is performed.

When determining that the position of the face SF is the same as its position at the time when step S22 is performed (Yes in S44), the CPU 104 determines that the subject S as a tracking target has not moved, and ends the program. When determining that the position of the face SF is different from its position at the time when step S22 is performed (No in S44), the CPU 104 determines that the subject S as a tracking target is moving. The CPU 104 advances the processing to step S22 and starts tracking the subject S. In the second embodiment, as described above, in response to the position of the face SF of the subject S changing from its position at which the subject S is seated to its position at which the subject S is standing, the target angle is changed from d4 to d5 and the angle of the imager 12 is also changed.

As described above, the method for controlling the optical device 10 according to the second embodiment causes the identifier 114 to perform face authentication on the face SF of the specified subject S to identify the subject S. When the identified subject S has moved, the movement detector 116 detects the position to which the subject S has moved based on the difference in the position of the face SF. In response to the reference line M1 and the allowable range A2 being respectively replaced with (set to) the new reference line M2 and the allowable range A3, the angle of the imager 12 is changed. When the deviation angle of the imager 12 changes due to vibrations of the optical device 10, correction is performed based on the deviation angle in the intersecting direction from the reference line M2, thus reducing blur in an image obtained by the imager 12. In other words, this method can change the direction of the imager 12 to follow the subject S, and can also reduce image blur.

With the method for controlling the optical device 10 according to the second embodiment, the subject threshold is less than the imager threshold. In other words, the allowable range A3 is smaller as the angle of the imager 12 is closer to the angle at which the imager 12 faces the subject S. This reduces a deviation between the imaging position of the face SF of the subject S when the imager 12 reaches the target angle d5 on the reference line M2 and the position of the face SF in an obtained actual image.

With the method for controlling the optical device 10 according to the second embodiment, the acceleration AC of the actuator 30 changing the angle of the imager 12 is smaller when the angle of the imager 12 is closer to the reference line M1 or the reference line M2. This reduces the likelihood that the imager 12 moves unintendedly under its inertial force when the imager 12 reaches the target angle d5, thus reducing a deviation of the angle of the imager 12 from the target angle d5.

### Components in Third Embodiment

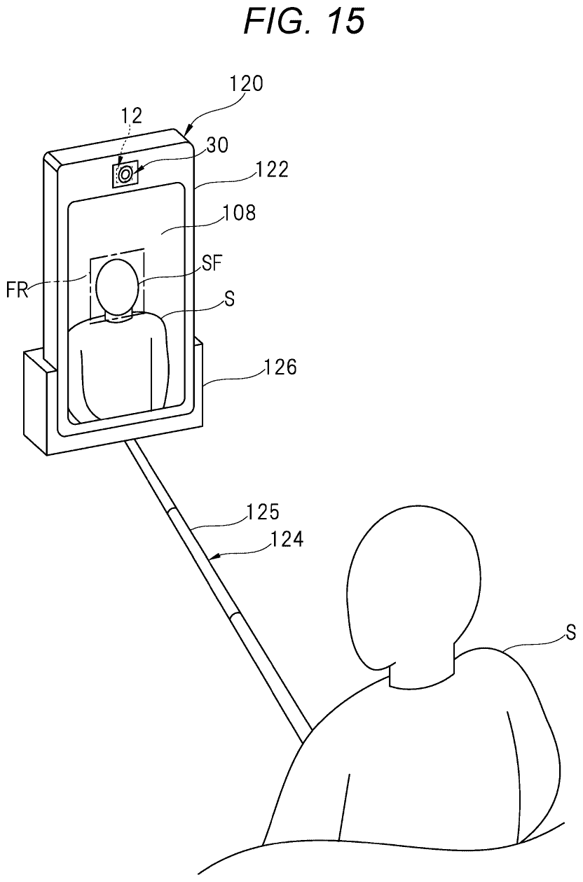

FIG. 15 shows the subject S taking a selfie with an optical device 120 according to a third embodiment. The same components of the optical device 120 and the same processes in a method for controlling the optical device 120 as in the first and second embodiments are denoted with the same reference numerals and will not be described, or the figure numbers will not be referred to.

The method for controlling the optical device 120 differs from those according to the first and second embodiments in that the method uses the optical device 120 alone without using the communication terminal 100 or the communication terminal 110. The optical device 120 differs from the optical device 10 in that the body case 11 is replaced with a case 122, the case 122 includes the display panel 108, and the controller 20 has the functions of the controller 102. The other components are the same as in the first and second embodiments.

The optical device 120 is supported by a support 124. The support 124 includes a rod 125 extendable in one direction and an attachment 126 fixed to the tip of the rod 125. The case 122 includes a lower portion that is detachably attached to the attachment 126. The subject S can take a selfie with the optical device 120 by extending the rod 125 in one direction with the case 122 attached to the attachment 126 and gripping an end portion of the rod 125.

The selection frame FR that is quadrilateral appears on the display panel 108. The selection frame FR can be moved to an intended position by touching the display panel 108 with a finger. A target in the selection frame FR is at the center of an image obtained by the imager 12. In other words, the actuator 30 operates to change the angle of the imager 12 to cause a target specified with the selection frame FR to be at the center of an image.

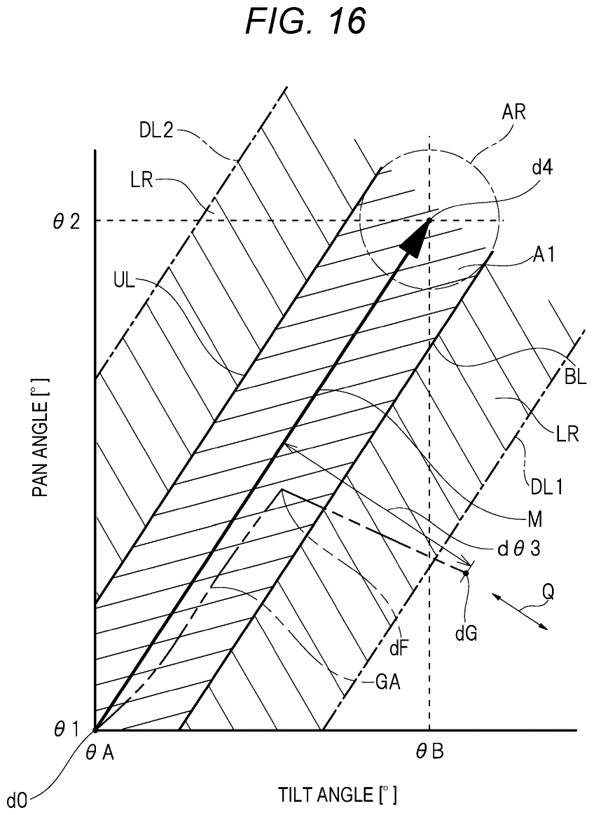

FIG. 16 shows, in addition to the reference line M and the boundaries BL and UL, an imaginary line GA representing the actual changes in the angle of the imager 12, a lower limit line DL1, and an upper limit line DL2. The lower limit line DL1 is defined in an area in which the deviation angle from the reference line M is greater than the deviation angle of the boundary BL. The upper limit line DL2 is defined in an area in which the deviation angle from the reference line M is greater than the deviation angle of the boundary UL. The range hatched with diagonal lines between the lower limit line DL1 and the upper limit line DL2 is defined as a limit range LR.

FIG. 16 shows the angle of the imager 12 exceeding the allowable range A1 and further exceeding the limit range LR (causing a deviation angle d03) during change of the orientation of the imager 12 (FIG. 15) to the target angle d4 based on the reference line M. In FIG. 16, the angle of the imager 12 is within the allowable range A1 along the reference line M until the angle of the imager 12 reaches an angle dF. However, in response to the optical device 120 (FIG. 15) receiving hand-held camera shake at the angle dF, the angle of the imager 12 exceeds the limit range LR (lower limit line DL1) with the deviation angle d03.

The angle of the imager 12 exceeding the limit range LR is less likely to fall within the allowable range A1 when the actuator 30 (FIG. 15) is operated. Thus, the optical device 120 prestores a program that ends the process of changing the angle of the imager 12 and the imaging performed by the imager 12 in response to the angle of the imager 12 exceeding the limit range LR.

### Effects of Components in Third Embodiment

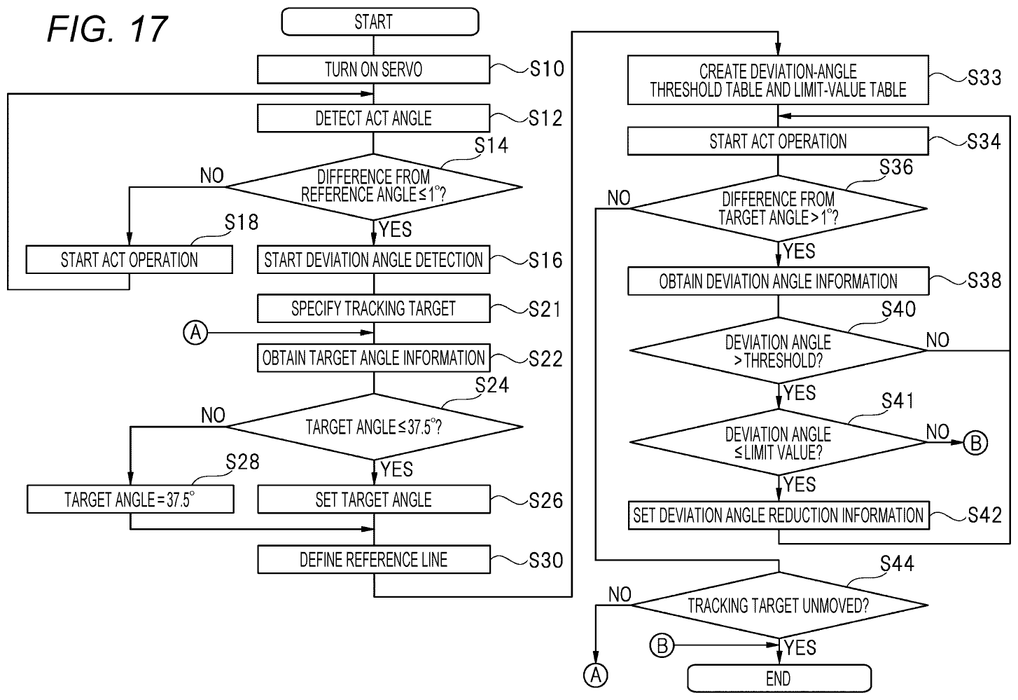

A method for controlling the optical device 120 according to the third embodiment will now be described with reference to the flowchart shown in FIG. 17. For the components of the optical device 120 (FIG. 15), FIGS. 1 to 5 and FIGS. 15 and 16 are to be referred to, and the figure numbers are not individually referred to. The same effects as in the first embodiment will not be described.

The processes shown in FIG. 17 are performed by the CPU 22 that loads and executes a program (not shown) after reading the program from the memory 24. For example, the program starts after the subject S operates the display panel 108 to set (performs face authentication on) the face SF of the subject S. The angle of the imager 12 is then changed to cause the set face SF to be at the center portion of the display panel 108. The optical device 120 is pre-attached to the attachment 126. The subject S has already started taking a selfie with the rod 125 extended.

The same steps as in the first and second embodiments are denoted with the same reference numerals and will not be described. More specifically, the flowchart in the third embodiment differs from the flowchart (FIG. 14) in the second embodiment in that step S33 is set in place of step S32 and step S41 is added.

After step S30, the processing advances to step S33. In step S33, the CPU 104 defines the allowable range A1 and the limit range LR of vibrations based on the reference line M. The processing then advances to step S34. More specifically, the CPU 104 creates a table of combinations of the values of the tilt angle and the values of the pan angle, and then determines thresholds corresponding to the boundaries BL and UL and limit values corresponding to the lower limit line DL1 and the upper limit line DL2. The CPU 104 can thus apply the value of the tilt angle and the value of the pan angle obtained by the detector 72 to the table to determine whether the angle of the imager 12 is within the allowable range A1 and whether the angle of the imager 12 exceeds the limit range LR. Step S33 is an example of setting a limit value greater than a threshold for the deviation angle in the intersecting direction.

In step S40, when the obtained deviation angle dθ3 is greater than the threshold (Yes in S40), the processing advances to step S41. When the obtained deviation angle dθ3 is less than or equal to the threshold (No in S40), the processing advances to step S34.

In step S41, the CPU 104 determines whether the deviation angle d03 obtained in step S40 is less than or equal to the limit values. More specifically, the CPU 104 defines an angular value corresponding to the difference between the reference line M and the lower limit line DL1 and an angular value corresponding to the difference between the reference line M and the upper limit line DL2 as the limit values, and compares the obtained deviation angle d03 with the limit values. When the obtained deviation angle d03 is less than or equal to the limit values (Yes in S41), the processing advances to step S42. When the obtained deviation angle d03 is greater than the limit values (No in S41), the CPU 104 ends the program. Step S41 is an example of stopping the operation of changing, with the actuator 30, the angle of the imager 12 in response to the deviation angle d03 being greater than the limit values.

When the angle of the imager 12 exceeds the limit range LR for the reference line M, the actuator 30 cannot correct the angle of the imager 12. Driving the actuator 30 that cannot correct the angle of the imager 12 causes wasteful consumption of the battery power. The method for controlling the optical device 120 according to the third embodiment thus stops the operation of the actuator 30 when the deviation angle of the imager 12 in the intersecting direction is out of the limit range LR to reduce the likelihood of wasteful consumption of power by the actuator 30.

### Components in Fourth Embodiment

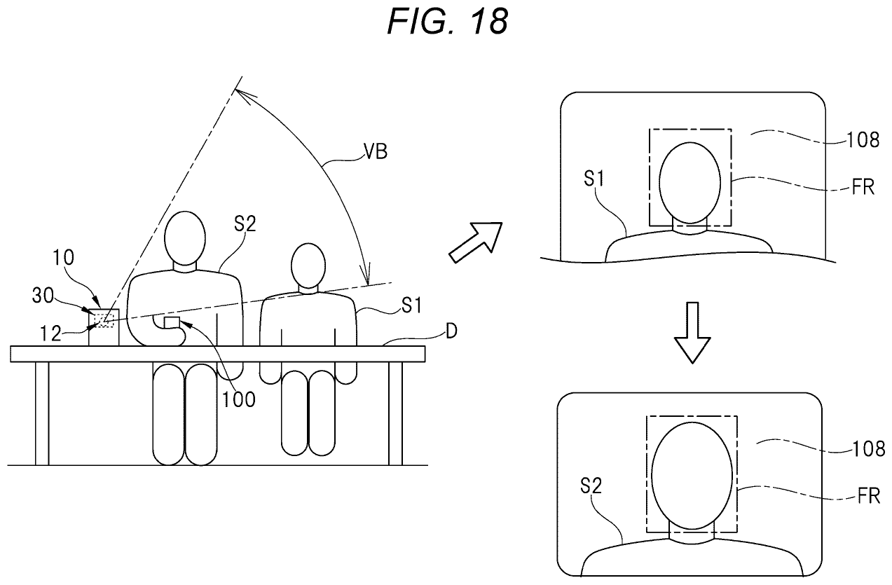

FIG. 18 shows the subject imaged by the imager 12 switched from the first subject S1 to the second subject S2 in an optical device 10 according to a fourth embodiment. The subject includes the first subject S1 and the second subject S2. The same components of the optical device 10 and the communication terminal 100 as in the first embodiment are denoted with the same reference numerals and will not be described.

The optical device 10 is placed on the top of the desk D. The optical device 10 is supported on the support plate (not shown). For example, the first subject S1 and the second subject S2 are in the range of an angle of view VB of the imager 12. In other words, the imager 12 is oriented toward the first subject S1 and the second subject S2 to allow the first subject S1 and the second subject S2 to be in the angle of view VB. The first subject S1 is farther from the optical device 10. The second subject S2 is closer to the optical device 10. The selection frame FR appears on the display panel 108. The selection frame FR is specified by, for example, the second subject S2 operating the communication terminal 100.

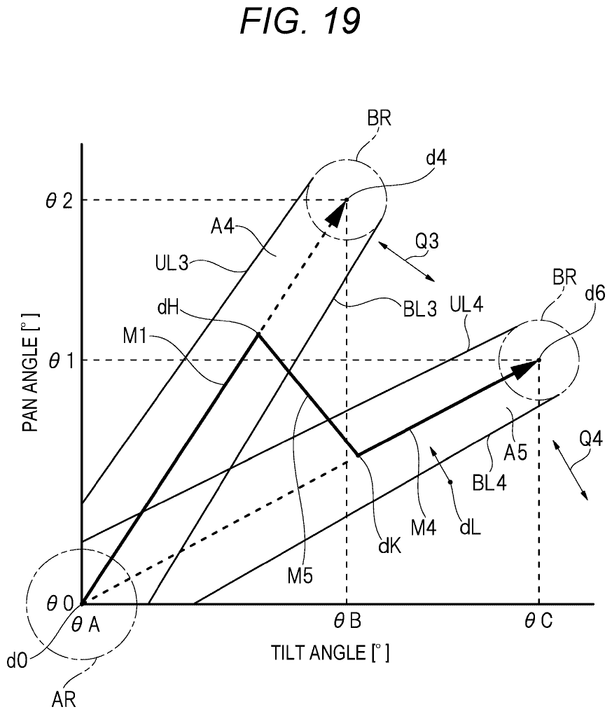

FIG. 19 shows the reference line M1 used when the orientation of the imager 12 (FIG. 18) is changed from the initial angle d0 to the target angle d4 and a reference line M4 used when the angle of the imager 12 is changed from the initial angle d0 to a target angle d6. The reference lines M1 and M4 are each indicated by an arrow. For example, the reference line is switched from M1 to M4 from the time point at which the imager 12 reaches an angle dH on the reference line M1 to the time point at which the imager 12 reaches an angle dK on the reference line M4. The reference for the angle of the imager 12 in switching the reference line from M1 to M4 is indicated by a reference line M5. The angle of the imager 12 is changed along the reference line M4 and to the target angle d6 after the reference line is switched from M1 to M5 at the angle dH. The reference line M1 is an example of a first reference line. The reference line M4 is an example of a second reference line.

The target angle d4 is the angle of the imager 12 at which the imager 12 can capture an image of the first subject S1. The target angle d6 is the angle of the imager 12 at which the imager 12 can capture an image of the second subject S2. The target angle d4 is represented by the tilt angle θB (°) and the pan angle θ2 (°). The target angle d6 is represented by the tilt angle θC (°) and a pan angle θ1 (°). θA<θB<θC is satisfied, and θ0<θ1<θ2 is satisfied. When a subject to be imaged is switched from the first subject S1 to the second subject S2, both the tilt angle and the pan angle of the imager 12 are changed.

In FIG. 19, an intersecting direction intersecting with the reference line M1 is indicated by an arrow Q3. A direction intersecting with the reference line M4 is indicated by an arrow Q4. In FIG. 19, as described above, the specified subject is changed from the first subject S1 to the second subject S2 before the angle of the imager 12 reaches the target angle d4, and the angle of the imager 12 is changed to the target angle d6.

The allowable range at the initial angle d0 is indicated by the circle AR. The allowable range at each of the target angles d4 and d6 is indicated by the circle BR. The lower limits for the reference line M1 are indicated by a boundary BL3. The upper limits are indicated by a boundary UL3. The range between the boundary BL3 and the boundary UL3 is defined as an allowable range A4 of the deviation angle. Similarly, the lower limits for the reference line M4 are indicated by a boundary BL4. The upper limits are indicated by a boundary UL4. The range between the boundary BL4 and the boundary UL4 is defined as an allowable range A5 of the deviation angle. The allowable ranges A4 and A5 are both smaller as the angle of the imager 12 is closer to the target angle d4 or d6.

### Effects of Components in Fourth Embodiment

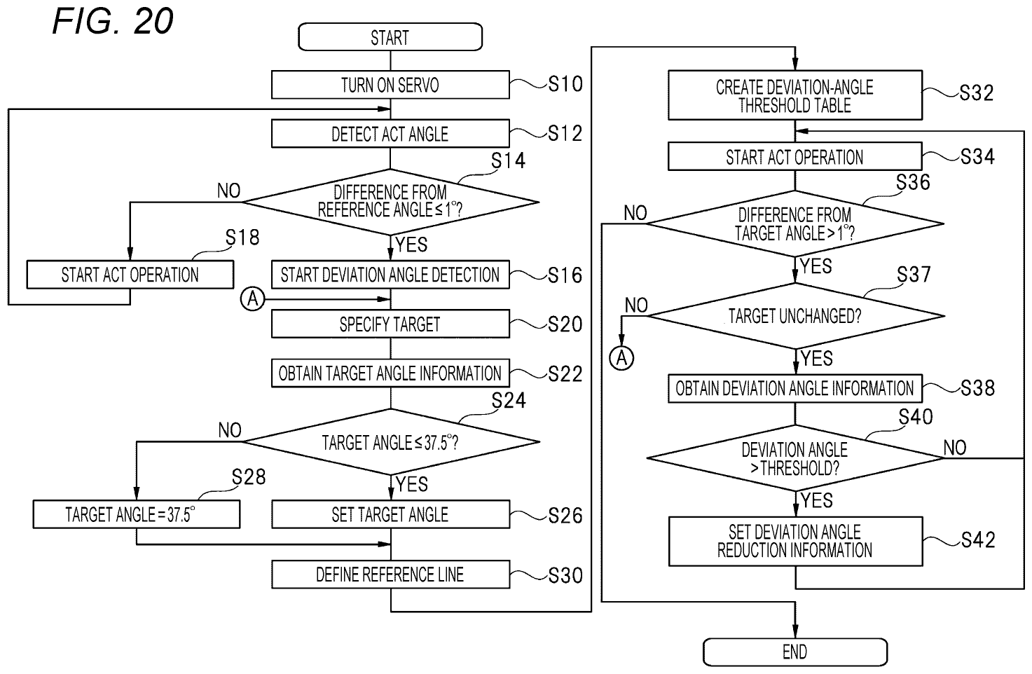

A method for controlling the optical device 10 according to the fourth embodiment will now be described with reference to the flowchart shown in FIG. 20. For the components of the optical device 10 and the communication terminal 100, FIGS. 1 to 5 and FIGS. 18 and 19 are to be referred to, and the figure numbers are not individually referred to. The same effects as in the first embodiment will not be described.

The processes shown in FIG. 20 are performed by the CPU 22 that loads and executes a program (not shown) after reading the program from the memory 24. For example, the program starts in response to the second subject S2 operating the display panel 108 to set (perform face authentication on) a face SF1 of the first subject S1. The angle of the imager 12 is then changed to cause the set face SF1 to be at the center portion of the display panel 108. In this example, the display panel 108 is operated to set a face SF2 of the second subject S2 during change of the angle of the imager 12 toward the first subject S1.

The same steps as in the first, second, and third embodiments are denoted with the same reference numerals and will not be described. More specifically, the flowchart in the fourth embodiment differs from the flowchart (FIG. 14) in the second embodiment in that step S37 is set in place of step S44.

Step S20 is an example of specifying the first subject S1 or the second subject S2. Steps S30 and S32 are examples of defining the reference line M1 and setting a first threshold (allowable range A4) as the threshold in response to the first subject S1 being specified. Step S34 is an example of starting an operation of changing, with the actuator 30, the angle of the imager 12 along the reference line M1.

Further, step S34 is also an example of changing, with the actuator 30, the angle of the imager 12 until the deviation angle in the intersecting direction falls below the first threshold in response to the deviation angle in the intersecting direction from the reference line M1 exceeding the first threshold in changing, with the actuator 30, the angle of the imager 12 along the reference line M1.

In step S36, the CPU 22 determines whether the angular difference is greater than 1°. When the angular difference is greater than 1° (Yes in S36), the processing advances to step S37. When the angular difference is less than or equal to 1° (No in S36), the CPU 22 determines that the imager 12 has reached the target angle d4 and ends the program.

In step S37, the CPU 22 determines whether the target remains unchanged based on specification information from the selection frame FR. When the target remains unchanged (Yes in S37), the processing advances to step S38. When the target is changed (No in S37), or in other words, when the target is changed from the first subject S1 to the second subject S2, the processing advances to step S20. Step S37 and steps S20 to S32 after the target is changed are examples of setting the reference line M4 and a second threshold (allowable range A5) as the threshold in response to the second subject S2 being specified in changing, with the actuator 30, the angle of the imager 12 along the reference line M1. Steps S38 to S42 are the same as in the second embodiment.

Step S34 after the target is changed is an example of starting an operation of changing, with the actuator 30, the angle of the imager 12 along the reference line M4.

Further, steps S34 to S42 are examples of changing, with the actuator 30, the angle of the imager 12 until the deviation angle in the intersecting direction falls below the second threshold in response to the deviation angle in the intersecting direction from the reference line M4 exceeding the second threshold in changing, with the actuator 30, the angle of the imager 12 along the reference line M4.

As described above, the method for controlling the optical device 10 according to the fourth embodiment changes the reference line and the allowable range when the target is changed. As shown in FIGS. 18 and 19, during movement of the imager 12 with the actuator 30 to the target angle d6 to which the target angle has been changed, the angle of the imager 12 may exceed the boundary BL4 and reach an angle DL in response to vibrations received by the optical device 10. In this case, the actuator 30 corrects the angle (difference angle) of the imager 12 from the angle dL to an angle within the allowable range A5. This thus reduces image blur when the imaging target is changed from the first subject S1 to the second subject S2.

### Modifications

The present invention is not limited to any of the first, second, third, and fourth embodiments described above, and can be modified variously without departing from the spirit and scope of the invention.

The number of magnetic poles of each of the first magnets 56 and the second magnets 58 may be different from the number of magnetic poles shown in FIG. 3.

In the actuator 30, the center for changing the angle in the pan direction and the center for changing the angle in the tilt direction may not be aligned with the reference point C. For example, a two-axis actuator displaceable in the X-direction or the Y-direction may be added, and the angles in the pan direction and the tilt direction may be changed after the actuator 30 is moved in the X-direction or the Y-direction. The angle of the imager 12 may not have the components in both the pan direction and the tilt direction, and may have a component in one of the pan direction or the tilt direction alone.

In the first, second, and fourth embodiments, the limit range LR may be set, and the operation of changing the angle of the imager 12 may be stopped in response to the angle of the imager 12 exceeding the limit range LR.

The acceleration AC of the actuator 30 may not be set smaller when the angle of the imager 12 is closer to the reference line M. The allowable ranges A1, A2, and A3 may not be set smaller as the angle of the imager 12 is closer to the target angle.

The target may not be specified with the selection frame FR operated on the display panel 108. For example, a list of target information (information about the faces of subjects) may be preset, the target may be selected from the list and registered, and face recognition may be performed automatically to specify the target.

The number of subjects may be three or more rather than one or two. In this case, the subject may be switched twice or more times, rather than once.

In the first, second, third, and fourth embodiments, the determination as to whether the angle of the imager 12 is deviated (whether blur occurs) may be performed after a focus assembly (not shown) is operated to adjust the focal point.

The optical device 10 according to the first, second, and fourth embodiments may have the functions of the communication terminal 100 or 110, and the optical device 10 alone may be used. In other words, the optical device 10 according to the first, second, and fourth embodiments may not be used with the communication terminal 100 or 110.

The reference angle is an orientation of the optical axis for when the imager captures an image with the subject positioned at the center of the image. The deviation angle is the amount of deviation of the angle from the reference angle. The drive may not rotate the imager and may slide the imager in a set direction. With this structure, the orientation of the optical axis is substantially constant. To position the subject at the center of an image, an imaginary line connecting the center of the imager and the center of the subject is defined, and the imager is slid to align the optical axis direction with the direction of the imaginary line. In this case, a deviation between the direction of the imaginary line and the optical axis direction is a deviation (deviation angle) of the optical axis. In other words, in the structure in which the imager is slid as well, the deviation angle can be corrected with the imaginary line connecting the center of the imager and the center of the subject used as a reference line. The deviation angle in a direction intersecting with the reference line indicates vibrations (including hand-held camera shake) as disturbance. As described above, the control method according to one or more embodiments of the disclosure is also applicable to the structure in which the imager is slid.

The method according to one or more embodiments of the disclosure may have aspects described below.

(1) A method for controlling an optical device, the optical device including an imager to capture an image of at least one subject, a drive to change an angle of the imager, and an obtainer to obtain information about a deviation angle from a reference angle of the imager, the method comprising:
specifying the at least one subject;
defining, in response to the at least one subject being specified, an imaginary line connecting a center of the imager and a center of the at least one subject as a reference line representing the reference angle;
setting at least one threshold of the deviation angle from the reference angle of the imager in an intersecting direction intersecting with the reference line;
starting an operation of changing, with the drive, the angle of the imager along the reference line;
obtaining, with the obtainer, the information about the deviation angle in the intersecting direction; and
changing, with the drive, the angle of the imager until the deviation angle in the intersecting direction falls below the at least one threshold in response to the deviation angle in the intersecting direction exceeding the at least one threshold in changing, with the drive, the angle of the imager along the reference line, and continuing the operation of changing, with the drive, the angle of the imager along the reference line after the deviation angle in the intersecting direction falls below the at least one threshold.

(2) The method according to (1), further comprising:
specifying a first subject or a second subject, the first subject and the second subject being included in the at least one subject;
defining a first reference line as the reference line and setting a first threshold as the at least one threshold in response to the first subject being specified;
starting an operation of changing, with the drive, the angle of the imager along the first reference line;
changing, with the drive, the angle of the imager until the deviation angle in the intersecting direction falls below the first threshold in response to the deviation angle in the intersecting direction from the first reference line exceeding the first threshold in changing, with the drive, the angle of the imager along the first reference line;
defining a second reference line as the reference line and setting a second threshold as the at least one threshold in response to the second subject being specified in changing, with the drive, the angle of the imager along the first reference line;
starting an operation of changing, with the drive, the angle of the imager along the second reference line; and
changing, with the drive, the angle of the imager until the deviation angle in the intersecting direction falls below the second threshold in response to the deviation angle in the intersecting direction from the second reference line exceeding the second threshold in changing, with the drive, the angle of the imager along the second reference line.

(3) The method according to (1), wherein
the optical device operates by transmitting and receiving information to and from a communication terminal,
the communication terminal includes
   an identifier to identify the at least one subject, and
   a movement detector to detect movement of the identified at least one subject from a first position to a second position, and
the method comprises identifying, with the identifier, the at least one subject in response to the at least one subject being specified,
defining, in response to the at least one subject being at the first position, an imaginary line connecting the center of the imager and the first position as the reference line before the movement,
defining, in response to the movement detector detecting the movement of the at least one subject to the second position, an imaginary line connecting the center of the imager and the second position as a new reference line,
setting, in response to the at least one subject being at the second position, a new threshold corresponding to the new reference line,
changing the angle of the imager along the new reference line, and
changing, with the drive, the angle of the imager until the deviation angle falls below the new threshold in response to the deviation angle exceeding the new threshold in changing the angle of the imager with the drive, and continuing an operation of changing, with the drive, the angle of the imager along the new reference line after the deviation angle falls below the new threshold.

(4) The method according to any one of (1) to (3), wherein
the at least one threshold includes a subject threshold and an imager threshold set for an area closer to the imager than the subject threshold, and
the subject threshold is less than the imager threshold.

(5) The method according to any one of (1) to (4), wherein
the drive changing the angle of the imager has a lower acceleration when the angle of the imager is closer to the reference line.

(6) The method according to any one of (1) to (5), further comprising:
setting, for the deviation angle in the intersecting direction, a limit value greater than the at least one threshold; and
stopping the operation of changing, with the drive, the angle of the imager in response to the deviation angle being greater than the limit value.

(7) The method according to any one of (1) to (6), wherein
the angle of the imager has components in a pan direction and a tilt direction perpendicular to each other, and
the drive changes the angle of the imager in the pan direction and the tilt direction.

What is claimed is:

1. A method for controlling an optical device, the optical device including an imager to capture an image of at least one subject, a drive to change an angle of the imager, and an obtainer to obtain information about a deviation angle from a reference angle of the imager, the method comprising:
specifying the at least one subject;
defining, in response to the at least one subject being specified, an imaginary line connecting a center of the imager and a center of the at least one subject as a reference line representing the reference angle;
setting at least one threshold of the deviation angle from the reference angle of the imager in an intersecting direction intersecting with the reference line;
starting an operation of changing, with the drive, the angle of the imager along the reference line;
obtaining, with the obtainer, the information about the deviation angle in the intersecting direction; and
changing, with the drive, the angle of the imager until the deviation angle in the intersecting direction falls below the at least one threshold in response to the deviation angle in the intersecting direction exceeding the at least one threshold in changing, with the drive, the angle of the imager along the reference line, and continuing the operation of changing, with the drive, the angle of the imager along the reference line after the deviation angle in the intersecting direction falls below the at least one threshold.

2. The method according to claim 1, further comprising:
specifying a first subject or a second subject, the first subject and the second subject being included in the at least one subject;
defining a first reference line as the reference line and setting a first threshold as the at least one threshold in response to the first subject being specified;
starting an operation of changing, with the drive, the angle of the imager along the first reference line;
changing, with the drive, the angle of the imager until the deviation angle in the intersecting direction falls below the first threshold in response to the deviation angle in the intersecting direction from the first reference line exceeding the first threshold in changing, with the drive, the angle of the imager along the first reference line;
defining a second reference line as the reference line and setting a second threshold as the at least one threshold in response to the second subject being specified in changing, with the drive, the angle of the imager along the first reference line;
starting an operation of changing, with the drive, the angle of the imager along the second reference line; and
changing, with the drive, the angle of the imager until the deviation angle in the intersecting direction falls below the second threshold in response to the deviation angle in the intersecting direction from the second reference line exceeding the second threshold in changing, with the drive, the angle of the imager along the second reference line.

3. The method according to claim 1, wherein
the optical device operates by transmitting and receiving information to and from a communication terminal,
the communication terminal includes
an identifier to identify the at least one subject, and
a movement detector to detect movement of the identified at least one subject from a first position to a second position, and
the method comprises identifying, with the identifier, the at least one subject in response to the at least one subject being specified,
defining, in response to the at least one subject being at the first position, an imaginary line connecting the center of the imager and the first position as the reference line before the movement,
defining, in response to the movement detector detecting the movement of the at least one subject to the second position, an imaginary line connecting the center of the imager and the second position as a new reference line,
setting, in response to the at least one subject being at the second position, a new threshold corresponding to the new reference line,
changing the angle of the imager along the new reference line, and
changing, with the drive, the angle of the imager until the deviation angle falls below the new threshold in response to the deviation angle exceeding the new threshold in changing the angle of the imager with the drive, and continuing an operation of changing, with the drive, the angle of the imager along the new reference line after the deviation angle falls below the new threshold.

4. The method according to claim 3, wherein
the at least one threshold includes a subject threshold and an imager threshold set for an area closer to the imager than the subject threshold, and
the subject threshold is less than the imager threshold.

5. The method according to claim 4, wherein
the drive changing the angle of the imager has a lower acceleration when the angle of the imager is closer to the reference line.

6. The method according to claim 1, further comprising:
setting, for the deviation angle in the intersecting direction, a limit value greater than the at least one threshold; and
stopping the operation of changing, with the drive, the angle of the imager in response to the deviation angle being greater than the limit value.

7. The method according to claim 1, wherein
the angle of the imager has components in a pan direction and a tilt direction perpendicular to each other, and
the drive changes the angle of the imager in the pan direction and the tilt direction.
